(19) United States
(12) Patent Application Publication
(10) Pub. No.: US 2024/0209198 A1
(43) Pub. Date: Jun. 27, 2024

(54) OLEFIN-BASED POLYMER COMPOSITIONS WITH IMPROVED CURE

(71) Applicant: Dow Global Technologies LLC, Midland, MI (US)

(72) Inventors: Yabin Sun, Shanghai (CN); Gaoxiang Wu, Pearland, TX (US); Jeffrey C. Munro, Bellaire, TX (US); Colin Li Pi Shan, Pearland, TX (US); Kainan Zhang, Shanghai (CN)

(21) Appl. No.: 18/556,247

(22) PCT Filed: Jun. 30, 2021
(86) PCT No.: PCT/CN2021/103385

§ 371 Date: Oct. 19, 2023

(51) Int. Cl. C08L 23/16

(52) U.S. Cl. CPC C08L 23/16; C08L 2312/08

(57) ABSTRACT

A process, and related composition, to form a crosslinked composition, the process comprising applying heat, and optionally radiation, to a composition that comprises at least the following components: a) elastomer, or an olefin-based polymer that has a density >0.920 g/cc, and wherein component a has a total unsaturation ≥0.20/1000 C; b) a molecule comprising at least one Si—H group; c) at least one peroxide; and d) optionally, at least one crosslinking coagent different from component b. A process, and related composition, to form a crosslinked composition, the process comprising applying radiation, and optionally heat, to a composition that comprises the following components: a) elastomer, or an olefin-based polymer that has a density ≥0.920 g/cc, and wherein component a has a total unsaturation ≥0.20/1000 C; b) a molecule comprising at least one Si—H group.

### BACKGROUND OF THE INVENTION

The demand for photovoltaic (PV) modules is growing. This growth is driven by government incentives for PV, as well as the increasing efficiency and cost competitiveness of PV power generation versus traditional grid power sources. PV encapsulation film is one of the important materials for a PV module. Currently, ethylene vinyl acetate (EVA) film is widely used as an encapsulating material for traditional solar cell modules, due to its excellent transparency and curing response. However, more recent, high efficiency PERC (Passivated Emitter and Rear Cell) bifacial modules exhibit high PID (potential induced degradation) risk when using traditional EVA as the encapsulant film. Olefin-based polymer compositions offer improved anti-PID performance, however, typically have a reduced peroxide curing response as compared to EVA. Moving die rheometer (MDR) is used to characterize the curing response, and generates a MH (the highest torque) value and a T90 (the time to achieve 90% torque increase) value. There is a need for new olefin-based compositions that provide an improved cure response, such as higher MH values and lower T90 values.

European Application EP2958151A1 discloses an encapsulant composition containing an ethylene/alpha-olefin encapsulant with density of 0.860-0.920 g/mL, MFR of 0.1-100, and the product N*V≥10, where N is the branch number derived from the comonomer and V is the total number of vinyl and vinylidene, both per 1000 C. The composition may also contain an alkoxyl silane or chlorosilane coupling agent to improve the strength of adhesion between the encapsulation film and the glass substrate Examples of such silane coupling agents include γ-chloropropyltrimethoxysilane, vinyltrichlorosilane, vinyltriethoxysilane, vinyltrimethoxysilane, vinyltris(β-methoxyethoxy)silane, γ-methacryl-oxypropyltrimethoxysilane, β-(3,4-epoxycyclohexyl)ethyltrimethoxysilane, γ-glycidoxy-propyltrimethoxysilane, vinyltriacetoxysilane, γ-mercaptopropyltrimethoxysilane, γ-amino-propyltrimethoxysilane, N-β-(aminoethyl)-γ-aminopropyltrimethoxysilane, and 3-acryloxypropyltrimethoxysilane. See also JP2012009688A (machine translation), where the total amount of vinyl, vinylidene, cis-vinylene, trans-vinylene, trisubstituted-vinylene in the ethylene/a-olefin copolymer is 0.22 (per 1000 C) or more.

International Publication WO2020/135680A1 discloses a curable composition for an encapsulant film; the curable composition comprising a telechelic polyolefin of the formula A¹L¹L²A² or an unsaturated polyolefin of the formula A¹L¹, and a curing component comprising a cross-linking agent, a coagent and a silane coupling agent. Cross-linking agents include peroxides; phenols; azides; aldehyde-amine reaction products; substituted ureas; substituted guanidines; substituted xanthates; substituted dithiocarbamates; sulfur-containing compounds, such as thiazoles, sulfenamides, thiuramidisulfides, paraquinonedioxime, dibenzoparaquinonedioxime, sulfur; imidazoles; silanes; metal oxides, such as zinc, magnesium, and lead oxides; dinitroso compounds, such as p-quinone-dioxime and r,r′-dibenzoylquinone-dioxime; and phenolformaldehyde resins containing hydroxymethyl or halomethyl functional groups and combinations thereof (see paragraph [0240]). Examples of suitable silane coupling agents include γ-chloropropyl trimethoxysilane, vinyl trimethoxy-silane, vinyl triethoxysilane, vinyl-tris-(β-methoxy)silane, allyltrimethoxysilane, γ-methacryloxypropyl trimethoxysilane, B-(3,4-ethoxy-cyclohexyl)ethyl trimethoxysilane, γ-glycidoxypropyl trimethoxysilane, γ-mercapto-propyltrimethoxysilane, γ-aminopropyl-trimethoxysilane, N-β-(aminoethyl)-γ-aminopropyl trimethoxysilane, and 3-(trimethoxy-silyl)propylmethacrylate, vinyl triacetoxysilane, γ-(meth)acryloxy, propyltrimethoxysilane, and combinations thereof (see paragraph [260]). See also WO2020/135708A1, WO2020/140058, WO2020/140061 and WO2020/140067.

European Application EP2637217A1 discloses an encapsulating material for a solar cell, and comprising an ethylene/α-olefin copolymer satisfying the following requirements (a1) to (a4): (a1) the content ratio of structural units derived from ethylene from 80 to 90 mol %, and the content ratio of structural units derived from the α-olefin (C3-C20) from 10 to 20 mol %; (a2) the MFR is equal to, or more than, 2 g/10 minutes and less than 10 g/10 minutes; (a3) the density from 0.865 to 0.884 g/cm³; and (a4) the shore A hardness from 60 to 85. The encapsulating material also contains a peroxide and a silane coupling agent. Some examples of silane coupling agents include vinyltriethoxysilane, vinyltrimethoxysilane, vinyltris(β-methoxyethoxysilane), γ-glycidoxy-propyltrimethoxysilane, γ-aminopropyl-triethoxysilane, γ-methacryloxypropyltrimethoxysilane. An organic peroxide can be used as a crosslinking agent.

U.S. Pat. No. 8,581,094 discloses a POE encapsulant design, wherein the polyolefin, for example, an ethylene/octene copolymer, is crosslinked, such that the copolymer contains less than about 70 percent xylene soluble extractables. U.S. Pat. No. 4,539,357 discloses a silicone composition comprising a blend of vinyl-containing gums, a silica reinforcing filler, a hydride cross-linking agent, and a peroxide curing catalyst. International publication WO 2002/072704 discloses a heat-curable silicone composition comprising a reactive silicone, a silicone hydride crosslinker, a rhodium metal catalyst and an inhibitor system, including a peroxide and an acetylenic compound. The combination of the inhibitor is disclosed as providing a higher shelf life at low temperature storage. U.S. Publication 2006/0205908 discloses curable liquid silicone rubbers that, with the appropriate levels of both silicon hydride and organic peroxides, provide fast curing, one part silicone systems.

However, there remains a need for new olefin-based polymer compositions and related crosslinking processes for improved cure performance. This need has been met by the follow invention.

### SUMMARY OF THE INVENTION

In a first aspect, a process to form a crosslinked composition, the process comprising applying heat, and optionally radiation, to a composition that comprises at least the following components:
a) an elastomer, or an olefin-based polymer that has a density >0.920 g/cc, and wherein component a has a total unsaturation ≥0.20/1000 C;
b) a molecule comprising at least one Si—H group;
c) at least one peroxide; and
d) optionally, at least one crosslinking coagent different from component b.

In a second aspect, a process to form a crosslinked composition, the process comprising applying radiation, and optionally heat, to a composition that comprises the following components:
a) an elastomer, or an olefin-based polymer that has a density >0.920 g/cc, and wherein component a has a total unsaturation ≥0.20/1000 C; and
b) a molecule comprising at least one Si—H group.

In a third aspect, a composition comprising at least the following components:
a) an elastomer, or an olefin-based polymer that has a density >0.920 g/cc, and wherein component a has a total unsaturation ≥0.20/1000 C;
b) a molecule comprising at least one Si—H group;
c) at least one peroxide, and
d) optionally, at least one crosslinking coagent different from component b.

In a fourth aspect, a composition comprising at least the following components:
a) an elastomer that has a total unsaturation ≥0.20/1000 C, or an olefin-based polymer that has a density >0.920 g/cc and a total unsaturation ≥0.20/1000 C, and wherein the elastomer is selected from the following:
   i) a telechelic polyolefin of the formula A¹L¹L²A²,
   ii) an ethylene/alpha-olefin/nonconjugated polyene interpolymer that has a Mooney Viscosity (ML1+4 at 125° C.) from 5 to 30,
   iii) an ethylene/alpha-olefin copolymer, or
   iv) an unsaturated polyolefin of the formula A¹L¹;
b) a molecule comprising at least one Si—H group.

### DETAILED DESCRIPTION OF THE INVENTION

Processes and related compositions have been discovered that provide excellent curing properties, such as a significant increase in the MH value, and a significant decrease in the T90 value.

In a first aspect, a process to form a crosslinked composition is provided, as discussed above. In a second aspect, a process to form a crosslinked composition is provided, as discussed above. Each process may comprise a combination of two or more embodiments, as described herein. Each component a, b, c and d may comprise a combination of two or more embodiments, as described herein.

In a third aspect, a composition is provided, as discussed above. In a fourth aspect, a composition is provided, as discussed above. Each composition may comprise a combination of two or more embodiments, as described herein. Each component a, b, c and d may comprise a combination of two or more embodiments, as described herein.

The following embodiments apply to the first through fourth aspect of the invention, unless stated otherwise.

In one embodiment, or a combination of two or more embodiments, each described herein, component a is an elastomer.

In one embodiment, or a combination of two or more embodiments, each described herein, the elastomer (component a) has a density ≥0.860, or ≥0.862, or ≥0.864, or ≥0.866, or ≥0.868, or ≥0.870 g/cc (1 cc=1 cm³). In one embodiment, or a combination of two or more embodiments, each described herein, the elastomer (component a) has a density ≤0.920, or ≤0.915, or ≤0.910, or ≤0.905, or ≤0.900, or ≤0.895, or ≤0.890, or ≤0.885, or ≤0.880 g/cc.

In one embodiment, or a combination of two or more embodiments, each described herein, the elastomer is selected from a telechelic polyolefin of the formula A¹L¹L²A², an unsaturated polyolefin of the formula A¹L¹, an ethylene/alpha-olefin/nonconjugated polyene interpolymer, or an ethylene/alpha-olefin copolymer.

In one embodiment, or a combination of two or more embodiments, each described herein component b comprises ≥2 Si—H groups, or ≥3 Si—H groups.

In one embodiment, or a combination of two or more embodiments, each described herein the silicon of the SiH in component b is bonded to at least one alkyl group, R.

In one embodiment, or a combination of two or more embodiments, each described herein the silicon of the SiH in component b is bonded to at least one alkoxyl group, RO, where R is an alkyl group.

In one embodiment, or a combination of two or more embodiments, each described herein the silicon of the SiH in component b is bonded to at least one Si—O group (see for example structures (s9)-(s16) below).

In one embodiment, or a combination of two or more embodiments, each described herein, component b comprises ≥1, or ≥2, or ≥3 siloxane groups (—Si—O—Si—).

In one embodiment, or a combination of two or more embodiments, each described herein, component b comprises an alkoxyl silane (R—O—Si), in addition to at least one Si—H group, where R is an alkyl group.

In one embodiment, or a combination of two or more embodiments, each described herein, component b comprises one or more double bonds

Also provided is a crosslinked composition formed from a process of one or more embodiments as described herein, or from a composition of one or more embodiments as described herein.

Also provided is an article comprising at least one component formed from a composition of one or more embodiments as described herein.

### Elastomers

An elastomer is a polymer with a viscoelasticity (i.e., both viscosity and elasticity) property. An elastomer includes, but is not limited to, the following: an ethylene/alpha-olefin/nonconjugated polyene interpolymer; a telechelic polyolefin of the formula A¹L¹L²A², an unsaturated polyolefin of the formula A¹L¹, an ethylene/alpha-olefin interpolymer, a polyisoprene, a polybutadiene, a styrene butadiene rubber, a nitrile rubber, a polychloroprene, a butyl rubber, a halogenated butyl rubber, and a halogenated nitrile rubber.

The ethylene/alpha-olefin/nonconjugated polyene interpolymers, as described herein, comprises, in polymerize form, ethylene, an alpha-olefin, and a nonconjugated polyene. The alpha-olefin may be either an aliphatic or an aromatic compound. Alpha-olefins include, but are not limited to, a C3-C20 alpha-olefins, further C3-C10 alpha-olefins, further C3-C8 alpha-olefins. In one embodiment, the interpolymer is an ethylene/propylene/nonconjugated diene interpolymer, further a terpolymer, further an EPDM. Suitable examples of nonconjugated polyenes include the C4-C40 nonconjugated dienes. Nonconjugated dienes include, but are not limited to, 5-ethylidene-2-norbornene (ENB), 5-vinyl-2-norbornene (VNB), dicyclopentadiene, 1,4-hexadiene, or 7-methyl-1,6-octadiene, and further from ENB, VNB, dicyclopentadiene or 1,4-hexadiene, and further from ENB or VNB, and further ENB.

The ethylene/alpha-olefin interpolymer comprises, in polymerize form, ethylene, and an alpha-olefin. Alpha-olefins include, but are not limited to, a C3-C20 alpha-olefins, further C3-C10 alpha-olefins, further C3-C8 alpha-olefins, such as propylene, 1-butene, 1-hexene, and 1-octene.

Telechelic polyolefins, such as those of the A¹L¹L²A² (Formula I), and unsaturated polyolefins, such as those of the A¹L¹ (Formula II), are each described below. See also WO 2020/140058 and WO 2020/140067, each incorporated herein by reference.

Telechelic polyolefin of Formula I: A¹L¹L²A², wherein:
L¹ is a polyolefin, and preferably an ethylene-based polymer, and further an ethylene/alpha-olefin interpolymer, and further an ethylene/alpha-olefin copolymer; note, L¹ (divalent) is bonded to A¹ and L².
A¹ is selected from the group consisting of the following:
a) a vinyl group, b) a vinylidene group of the formula CH₂═C(Y¹)—, c) a vinylene group of the formula Y¹CH—CH—, d) a mixture of a vinyl group and a vinylene group of the formula Y¹CH═CH—, e) a mixture of a vinyl group and a vinylidene group of the formula CH₂═C(Y¹)—, f) a mixture of a vinylidene group of the formula CH₂—C(Y₁)— and a vinylene group of the formula Y¹CH═CH—, and g) a mixture of a vinyl group, a vinylidene group of the formula CH₂—C(Y¹)—, and a vinylene group of the formula Y¹CH═CH—;
Y¹ at each occurrence, independently, is a C₁ to C₃₀ hydrocarbyl group;
L² is a C₁ to C₃₂ hydrocarbylene group; and
A² is a hydrocarbyl group comprising a hindered double bond.

Unsaturated polyolefin of Formula II: A¹L¹, wherein:
L¹ is polyolefin, and preferably an ethylene-based polymer, and further an ethylene/alpha-olefin interpolymer, and further an ethylene/alpha-olefin copolymer; note, L¹ (monovalent) is bonded to A¹;
A¹ is selected from the group consisting of the following: a) a vinyl group, b) a vinylidene group of the formula CH₂═C(Y¹)—, c) a vinylene group of the formula Y¹CH—CH—, d) a mixture of a vinyl group and a vinylene group of the formula Y¹CH═CH—, e) a mixture of a vinyl group and a vinylidene group of the formula CH₂═C(Y¹)—, f) a mixture of a vinylidene group of the formula CH₂═C(Y¹)— and a vinylene group of the formula Y¹CH═CH—, and g) a mixture of a vinyl group, a vinylidene group of the formula CH₂═C(Y¹)—, and a vinylene group of the formula Y¹CH═CH—; and
Y¹ at each occurrence, independently, is a C₁ to C₃₀ hydrocarbyl group.

For Formula I and Formula II, L¹ at each occurrence independently is a polyolefin, as described above, and may result, in part, from the polymerization (for example, coordination polymerization) of unsaturated monomers (and comonomers). Examples of suitable monomers (and comonomers) include, but are not limited to, ethylene and alpha-olefins of 3 to 30 carbon atoms, further 3 to 20 carbon atoms, such as, for example, propylene, 1-butene, 1-pentene, 3-methyl-1-butene, 1-hexene, 4-methyl-1-pentene, 3-methyl-1-pentene, 3,5,5-trimethyl-lhexene, 1-octene, 1-decene, 1-dodecene, 1-tetradecene, 1-hexadecene, 5-ethyl-1-nonene, 1-octadecene and 1-eicosene; conjugated or nonconjugated dienes, such as, for example, butadiene, isoprene, 4-methyl-1,3-pentadiene, 1,3-pentadiene, 1,4-pentadiene, 1,5-hexadiene, 1,4-hexadiene, 1,3-hexadiene, 1,5-heptadiene, 1,6-heptadiene, 1,3-octadiene, 1,4-octadiene, 1,5-octadiene, 1,6-octadiene, 1,7-octadiene, 1,9-decadiene, 7-methyl-1,6-octadiene, 4-ethylidene-8-methyl-1,7-nonadiene, and 5,9-dimethyl-1,4,8-decatriene, 5-methyl-1,4-hexadiene, 3,7-dimethyl-1,6-octadiene, 3,7-dimethyl-1,7-octadiene, and mixed isomers of dihydromyrcene and dihydroocimene; norbornene and alkenyl, alkylidene, cycloalkenyl and cycloalkylidene norbornenes, such as 5-ethylidene-2-norbornene, 5-vinyl-2-norbornene, dicyclopentadiene, 5-methylene-2-norbornene, 5-propenyl-2-norbornene, 5-isopropylidene-2-norbornene, 5-(4-cyclopentenyl)-2-norbornene, 5-cyclohexylidene-2-norbornene, and norbornadiene; and aromatic vinyl compounds such as styrenes, mono or polyalkylstyrenes (including styrene, o-methylstyrene, t-methylstyrene, m-methylstyrene, p-methylstyrene, o-dimethylstyrene, o-ethylstyrene, m-ethylstyrene and p-ethylstyrene).

Polyisoprenes include, for example, natural polyisoprene, such as cis-1,4-poly-isoprene (natural rubber (NR) and trans-1,4-polyisoprene (gutta-percha); and synthetic polyisoprene (IR for isoprene rubber). Polybutadienes (or BR for butadiene rubber) include, for example, polymers of 1,3-butadiene. Polychloroprenes include, for example, polymers of chloroprene. Butyl rubbers include, for example, copolymers of isobutylene and isoprene (IIR). Halogenated butyl rubbers include, for example, chloro butyl rubbers (CIIR) and bromo butyl rubbers (BIIR). Styrene-butadiene rubbers include, for example, copolymers of styrene and butadiene (SBR). Nitrile rubbers include, for example, copolymers of butadiene and acrylonitrile (NBR).

### Molecule Comprising at Least One Si—H Group

A molecule comprising at least one Si—H group refers to a chemical compound or a polymer that contains, in terms of a number, at least one Si—H group. Examples include, but are not limited to, 1,1,1,3,5,5,5-heptamethyltrisiloxane; 1,1,3,3-tetramethyldisiloxane; 3-((dimethylsilyl)oxy)-1,1,5,5-tetramethyl-3-phenyltrisiloxane; dimethylhydrogensiloxy modified silica; trimethyl terminated dimethyl-co-hydrogen methyl polysiloxane with nominal viscosity of 15 mPa·s and 0.78 wt % SiH; a hydride modified silica Q resin (for example HQM-105 or HQM-107 each available from Gelest); tris(dimethylsilyloxy)phenyl-silane; methyltris(dimethylsiloxy)silane; 1,3,5,7-tetramethylcyclotetrasiloxane; tetrakis(dimethylsiloxy)silane; 1,1,3,3,5,5-hexamethyltrisiloxane; 1,1,3,3-tetramethyl-disiloxane; triethoxysilane, or 1-(2-(trimethoxysilyl)ethyl)-1,1,3,3-tetramethyldisiloxane; hexenylsilane; allylsilane; vinylsilane; octenylsilane; hexenyldimethylsilane; octenyldimethylsilane; vinyldimethylsilane; vinyldiethylsilane; vinyldi(n-butyl)silane; vinylmethyloctadecylsilane; vinyidiphenylsilane; vinyldibenzylsilane; allyldimethylsilane; allyldiethylsilane; allyldi(n-butyl)silane; allylmethyloctadecylsilane; allyldiphenylsilane; bishexenylsilane; and allyidibenzylsilane; 5-hexenyl-dimethylsilane (HDMS); 7-octenyl-dimethylsilane (ODMS); allyldimethylsilane (ADMS); butyldimethylsilane; 1-(but-3-en-1-yl)-1,1,3,3-tetramethyldisiloxane (BuMMH); 1-(hex-5-en-1-yl)-1,1,3,3-tetramethyldisiloxane (HexMMH); (2-bicyclo[2.2.1]hept-5-en-2-yl)ethyl)-dimethylsilane (NorDMS) and 1-(2-bicyclo[2.2.1]hept-5-en-2-yl)ethyl)-1,1,3,3-tetramethyldisiloxane (NorMMH). Some silanes are shown below in structures (s1)-(s16):

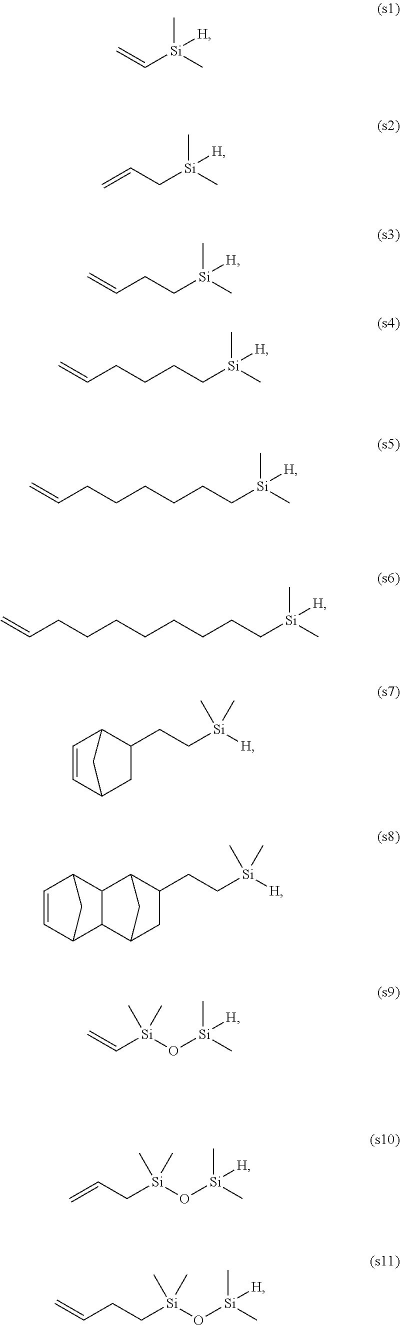

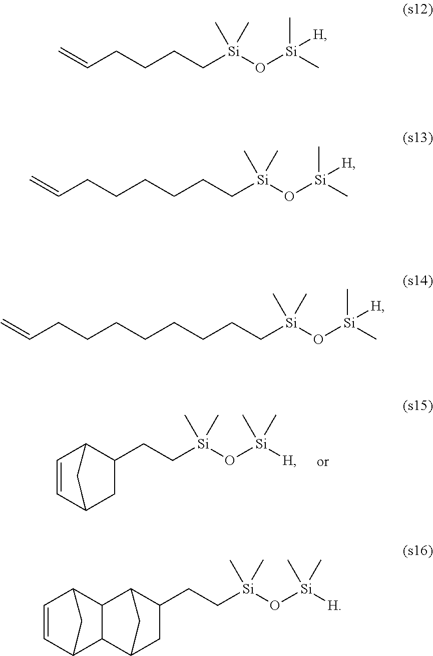

### Peroxide

As used herein, a peroxide contains at least one oxygen-oxygen bond (O—O). Peroxides include, but are not limited to, dialkyl, diaryl, dialkaryl, or diaralkyl peroxide, having the same or differing respective alkyl, aryl, alkaryl, or aralkyl moieties, and further each dialkyl, diaryl, dialkaryl, or diaralkyl peroxide, having the same respective alkyl, aryl, alkaryl, or aralkyl moieties.

Organic peroxides include, but are not limited to, tert-butylperoxy-2-ethylhexyl carbonate (TBEC); tert-amylperoxy-2-ethylhexyl carbonate (TAEC); tert-amylperoxy isopropyl carbonate; tert-butylperoxy isopropyl carbonate; 1,1-di(tert-butyl-peroxy) cyclohexane; 1,1-bis(tert-butylperoxy)-3,3,5-trimethylcyclohexane; 1,1-di(tert-amylperoxy)cyclohexane; dibenzoyl peroxide; dicumyl peroxide (“DCP”); tert-butyl peroxybenzoate; di-tert-amyl peroxide (“DTAP”); bis(t-butyl-peroxy isopropyl) benzene (“BIPB”), isopropylcumyl t-butyl peroxide; t-butyl-cumylperoxide; di-t-butyl peroxide; 2,5-bis(t-butylperoxy)-2,5-dimethylhexane; 2,5-bis(t-butylperoxy)-2,5-dimethylhexyne-3; 1,1-bis(t-butylperoxy)3,3,5-trimethylcyclohexane; isopropylcumyl cumylperoxide; butyl 4,4-di(tert-butylperoxy)valerate; di(isopropylcumyl) peroxide;. 3,6,9-triethyl-3,6,9-trimethyl-1,4,7-triperoxonane; and mixtures of two or more thereof.

### Additives

An inventive composition may comprise one or more additives. Additives include, but are not limited to, one or more alkoxyl silanes coupling agent, such as vinyltrimethoxy-silane (VTMS) or 3-(trimethoxysilyl)-propyl-methacrylate (VMMS) or alkoxyl silane coupling agent combinations; tetra ethoxyl silane TEOS (or pre-hydrolyzed products); crosslinking coagents, such as triallyl isocyanurate (TAIC), triallyl cyanurate (TAC), triallyl trimellitate (TATM), trimethylolpropane triacylate (TMPTA), trimethylolpropane trimethylacrylate (TMPTMA), 1,6-hexanediol diacrylate, pentaerythritol tetraacrylate, dipentaerythritol penta acrylate, tris (2-hydroxy ethyl) isocyanurate triacrylate, tri vinyl cyclohexane (TVCH), and alkenyl-functional monocyclic organosiloxanes disclosed in WO 2019/000311 and WO 2019/000654, which are incorporated herein by reference in their entirety (for example, a monocyclic organosiloxane of the formula [R1,R2SiO2/2]n, wherein subscript n is an integer greater than or equal to 3; each R1 is independently a (C2-C4)alkenyl or a H2C═C(R1a)-C(═O)—O—(CH₂)ₘ— wherein R1a is H or methyl and subscript m is an integer from 1 to 4; and each R2 is independently H, (C1-C4)alkyl, phenyl, or R1; for example 2,4,6,8-tetramethyl-2,4,6,8-tetravinyl cyclotetrasiloxane, 2,4,6-trimethyl-2,4,6-trivinyl-cyclotrisiloxane, or a combination thereof).

Additional additives include UV absorbers and/or stabilizers, such as TINUVIN 770; one or more anti-oxidants; processing aids, such as fluoro polymers, polydimethylsiloxane (PDMS), ultra-high molecular weight PDMS; ion scavengers, anti PID agents; fumed silica, nano Al₂O₃, nano-clay, and one or more other fillers.

### DEFINITIONS

Unless stated to the contrary, implicit from the context, or customary in the art, all parts and percentages are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, 50 wt % or a majority weight percent of an olefin, such as ethylene or propylene (based on the weight of the polymer), and optionally may comprise one or more comonomers.

The term “polyolefin,” as used herein, refers to a polymer that comprises, in polymerized form, 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, a majority weight percent of propylene (based on the weight of the polymer), and optionally may comprise one or more comonomers.

The term “ethylene-based polymer,” as used herein, refers to a polymer that comprises, in polymerized form, 50 wt % or a majority weight percent of ethylene (based on the weight of the polymer), and optionally may comprise one or more comonomers.

The term “ethylene/alpha-olefin interpolymer,” as used herein, refers to an interpolymer that comprises, in polymerized form, 50 wt % or a majority weight percent of ethylene (based on the weight of the interpolymer), and an alpha-olefin. Preferably, the ethylene/alpha-olefin interpolymer is a random interpolymer (i.e., comprises a random distribution of its monomeric constituents).

The term, “ethylene/alpha-olefin copolymer,” as used herein, refers to a copolymer that comprises, in polymerized form, 50 wt % or a majority weight percent of ethylene (based on the weight of the copolymer), and an alpha-olefin, as the only two monomer types. Preferably, the ethylene/alpha-olefin copolymer is a random copolymer (i.e., comprises a random distribution of its monomeric constituents).

The term “ethylene/alpha-olefin/nonconjugated polyene interpolymer,” as used herein, refers to an interpolymer that comprises, in polymerized form, ethylene, an alpha-olefin, and a nonconjugated polyene. In one embodiment, the “ethylene/alpha-olefin/nonconjugated polyene interpolymer,” comprises, in polymerized form, 50 wt % or a majority weight percent of ethylene (based on the weight of the interpolymer). The term “ethylene/alpha-olefin/-nonconjugated diene interpolymer,” as used herein, refers to an interpolymer that comprises, in polymerized form, ethylene, an alpha-olefin, and a nonconjugated diene. In one embodiment, the “ethylene/alpha-olefin/nonconjugated diene interpolymer,” comprises, in polymerized form, 50 wt % or a majority weight percent of ethylene (based on the weight of the interpolymer). Note, the terms “ethylene/alpha-olefin/nonconjugated polyene terpolymer” and “ethylene/alpha-olefin/nonconjugated diene terpolymer” are similarly defined; however, for each, the terpolymer comprises, in polymerized form, ethylene, the alpha-olefin and the polyene (or diene) as the only three monomer types.

The phrase “a majority weight percent,” as used herein, in reference to a polymer (or interpolymer, or terpolymer or copolymer), refers to the amount of monomer present in the greatest amount in the polymer.

The terms “hydrocarbon group,” “hydrocarbyl group,” and similar terms, as used herein, refer to a chemical group containing only carbon and hydrogen atoms.

The term “crosslinked composition,” as used herein, refers to a composition that has a network structure due to the formation of chemical bonds between polymer chains. The degree of formation of this network structure is indicated by an increase in the “MH-ML” differential. See Tables 6-12 below.

The phrases “applying heat,” “heat treated,” “heat treatment,” and similar terms, as used herein, in reference to a composition comprising an elastomer, or an olefin-based polymer that has a density >0.920 g/cc, as discussed herein, refer to heating the composition. Heat may be applied by electrical means (for example, a heating coil). Note, the temperature at which the heat treatment takes place, refers to the temperature of the composition (for example, the cure temperature of the composition).

The phrases “applying radiation,” “radiation treating,” “radiation treatment,” and similar terms, as used herein, in reference to a composition comprising an elastomer, or an olefin-based polymer that has a density >0.920 g/cc, as discussed herein, refer to the application of radiation (for example, high-energy electron beam, or UV) to the composition.

The phrases “thermally treating,” “thermal treatment,” and similar terms, as used herein, in reference to a composition comprising an elastomer, or an olefin-based polymer that has a density >0.920 g/cc, as discussed herein, refer to increasing the temperature of the composition by the application of heat, radiation or other means (for example, a chemical reaction), and preferably by the application of heat. Note, the temperature at which the thermal treatment takes place, refers to the temperature of the composition (for example, the cure temperature of the composition).

The term “siloxane group,” and similar terms, as used herein, refer to a chemical group or moiety comprising at least one “—Si—O—Si—” (siloxane) linkage.

The term “crosslinking coagent,” as used herein, refers to a compound that reacts with polymer chains, resulting in formation of chemical bonds between the polymer chains.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure, not specifically delineated or listed.

### Listing of Some Processes and Compositions

A] A process to form a crosslinked composition, the process comprising applying heat, and optionally radiation, to a composition that comprises at least the following components:
a) an elastomer, or an olefin-based polymer that has a density >0.920 g/cc, and wherein component a has a total unsaturation ≥0.20/1000 C;
b) a molecule comprising at least one Si—H group;
c) at least one peroxide; and
d) optionally, at least one crosslinking coagent different from component b.
B] A process to form a crosslinked composition, the process comprising applying radiation, and optionally heat, to a composition that comprises the following components:
a) an elastomer, or an olefin-based polymer that has a density >0.920 g/cc, and wherein component a has a total unsaturation ≥0.20/1000 C; and
b) a molecule comprising at least one Si—H group.
C] The process of A] or B] above, wherein component a has a total unsaturation ≥0.25/1000 C, or ≥0.30/1000 C, or ≥0.35/1000 C, or ≥0.40/1000 C, or ≥0.45/1000 C, or ≥0.50/1000 C ≥0.55/1000 C, or ≥0.60/1000 C, or ≥0.65/1000 C, or ≥0.70/1000 C, or ≥0.75/1000 C, or ≥0.80/1000 C, or ≥0.85/1000 C. or ≥0.90/1000 C, or ≥0.95/1000 C, or ≥1.00/1000 C, and/or ≤15.0/1000 C, or ≤10.0/1000 C, or ≤5.00/1000 C, or ≤2.00/1000 C, or ≤1.50/1000 C.
D] The process of any one of A]-C] (A] through C]) above, wherein component a is an elastomer.
E] The process of any one of A]-D] above, wherein the elastomer (component a) has a density ≥0.860, or ≥0.862, or ≥0.864, or ≥0.866, or ≥0.868, or ≥0.870 g/cc (1 cc=1 cm³).
F] The process of any one of A]-E] above, wherein the elastomer (component a) has a density ≤0.920, or ≤0.915, or ≤0.910, or ≤0.905, or ≤0.900, or ≤0.895, or ≤0.890, or ≤0.885, or ≤0.880 g/cc.
G] The process of any one of A]-F] above, wherein the elastomer is selected from a telechelic polyolefin of the formula A¹L¹L²A², an unsaturated polyolefin of the formula A¹L¹, an ethylene/alpha-olefin/nonconjugated polyene interpolymer, or an ethylene/alpha-olefin interpolymer.
H] The process of any one of A]-G] above, wherein the elastomer is a telechelic polyolefin of the formula A¹L¹L²A²; wherein L¹ is an ethylene-based polymer, further an ethylene/alpha-olefin interpolymer, and further a telechelic ethylene/alpha-olefin copolymer.
I] The process of H] above, wherein the alpha-olefin is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
J] The process of H] or I] above, wherein the telechelic polyolefin of the formula A¹L¹L²A² has a has a melt index (I2) ≥0.5 dg/min, or ≥1.0 dg/min, or ≥2.0 dg/min, or ≥5.0 dg/min, or ≥10 dg/min, or ≥12 dg/min, or ≥15 dg/min, or ≥18 dg/min, or ≥20 dg/min.
K] The process of any one of H]-J] above, wherein the telechelic polyolefin of the formula A¹L¹L²A² has a melt index (I2) ≤100 dg/min, or ≤90 dg/min, or ≤80 dg/min, or ≤70 dg/min, or ≤60 dg/min, or ≤50 dg/min, or ≤40 dg/min, or ≤35 dg/min.
L] The process of any one of A]-G] above, wherein the elastomer is an unsaturated polyolefin of the formula A¹L¹; wherein L¹ is an ethylene-based polymer, further an ethylene/alpha-olefin interpolymer, and further an ethylene/alpha-olefin copolymer.
M] The process of L] above, wherein the alpha-olefin is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene
N] The process of L] or M] above, wherein the unsaturated polyolefin of the formula A¹L¹ has a has a melt index (I2) ≥0.5 dg/min, or ≥0.8 dg/min, or ≥1.0 dg/min, or ≥2.0 dg/min, or ≥5.0 dg/min, or ≥10 dg/min.
O] The process of any one of L]-N] above, wherein the unsaturated polyolefin of the formula A¹L¹ has a melt index (I2) ≤100 dg/min, or ≤90 dg/min, or ≤80 dg/min, or ≤70 dg/min, or ≤60 dg/min, or ≤50 dg/min, or ≤40 dg/min.
P] The process of any one of A]-G] above, wherein the elastomer is an ethylene/alpha-olefin/non-conjugated polyene interpolymer, further an ethylene/alpha-olefin/nonconjugated diene interpolymer, and further an ethylene/alpha-olefin/nonconjugated diene terpolymer, further an EPDM.
Q1 The process of P] above, wherein the ethylene/alpha-olefin/nonconjugated polyene interpolymer has a Mooney Viscosity (ML1+4 at 125° C.) ≥5.0, or ≥10, or ≥12, or ≥14, or ≥16, or ≥18.
R] The process of P] or Q] above, wherein the ethylene/alpha-olefin/nonconjugated polyene interpolymer has a Mooney Viscosity (ML1+4 at 125° C.) ≤50, or ≤40, or ≤35, or ≤30, or ≤25, or ≤22, ≤20.
S] The process of any one of A]-G] above, wherein the elastomer is an ethylene/alpha-olefin interpolymer, and further an ethylene/alpha-olefin copolymer.
T] The process of S] above, wherein the alpha-olefin is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
U] The process of S] or T] above, wherein the ethylene/alpha-olefin interpolymer has a has a melt index (I2) ≥0.5 dg/min, or ≥1.0 dg/min, or ≥2.0 dg/min, or ≥5.0 dg/min, or ≥10 dg/min, or ≥15 dg/min, or ≥20 dg/min.
V] The process of any one of S]-U] above, wherein the ethylene/olefin interpolymer has a melt index (I2) ≤100 dg/min, or ≤90 dg/min, or ≤80 dg/min, or ≤75 dg/min or ≤70 dg/min, or ≤65 dg/min, or ≤60 dg/min, or ≤55 dg/min, or ≤50 dg/min, or <45 dg/min or ≤40 dg/min, or ≤35 dg/min or ≤30 dg/min.
W] The process of any one of A]-C] above, wherein component a is an olefin-based polymer that has a density >0.920 g/cc, further an ethylene-based polymer, further an ethylene/alpha-olefin interpolymer, and further an ethylene/alpha-olefin copolymer.
X] The process of W] above, wherein the alpha-olefin is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene
Y] The process of W] or X] above, wherein the olefin-based polymer (component a) has a density ≥0.925, or ≥0.930, or ≥0.935, or ≥0.940 g/cc (1 cc=1 cm³).
Z] The process of any one of W]-Y] above, wherein the olefin-based polymer (component a) has a density ≤0.960, or ≤0.955, or ≤0.950, or ≤0.945 g/cc.
A2] The process of any one of W]-Z] above, wherein the olefin-based polymer has a melt index (I2) ≥0.5 dg/min, or ≥0.8 dg/min, or ≥1.0 dg/min, or ≥2.0 dg/min, or ≥5.0 dg/min, or ≥10 dg/min.
B2] The process of any one of W]-A2] above, wherein the olefin-based polymer has a melt index (I2) ≤100 dg/min, or ≤90 dg/min, or ≤80 dg/min, or ≤70 dg/min, or ≤60 dg/min, or ≤50 dg/min, or ≤40 dg/min.
C2] The process of any one of A]-B2] above, wherein the component b comprises ≥2, or ≥3 Si—H groups.
D2] The process of any one of A]-C2] above, wherein the component b comprises ≥1, or ≥2, or ≥3 siloxane groups (—Si—O—Si—).
E2] The process of any one of A]-D2] above, wherein the component b comprises a —CR¹═CH₂ group, where R¹ is H or an alkyl.
F2] The process of any one of A]-E2] above, wherein the component b does not comprise a carbonyl group [—C(O)—] or a carboxyl group [—C(O)O—].
G2] The process of any one of A]-F2] above, wherein the silicon of the SiH in component b is bonded to at least one alkyl group (R).
H2] The process of any one of A]-G2] above, wherein the silicon of the SiH in component b is bonded to at least one alkoxyl group (RO), where R=alkyl.
I2] The process of any one of A]-H2] above, wherein the silicon of the SiH in component b is bonded to at least one Si—O group.
J2] The process of any one of A]-[2] above, wherein component b comprises an alkoxyl silane (R—O—Si) group, in addition to at least one Si—H group, where R=alkyl.
K2] The process of any one of A]-J2] above, wherein component b comprises one or more double bonds.
L2] The process of any one of A]-K2] above, wherein the component b comprises ≥20 wt %, or ≥22 wt %, or ≥24 wt %, or ≥26 wt %, or ≥28 wt %, or ≥30 wt %, or ≥32 wt % of Si, based on the weight of the molecule.
M2] The process of any one of A]-L2] above, wherein the component b comprises ≤60 wt %, or ≤55 wt %, or ≤50 wt %, or ≤48 wt %, or ≤46 wt %, or ≤44 wt %, or ≤42 wt % of Si, based on the weight of the molecule.
N2] The process of any one of A]-M2] above, wherein the component b has a weight ratio of Si to O ≥1.0, or ≥1.2, or ≥1.5, or ≥2.0, or ≥2.2, or ≥2.4, or ≥2.6, or ≥3.0.
O2] The process of any one of A]-N2] above, wherein the component b has a weight ratio of Si to O ≤5.0, or ≤4.8, or ≤4.6, or ≤4.4, or ≤4.2, or ≤4.0, or ≤3.8 of Si, based on the weight of the molecule.
P2] The process of any one of A]-M2] above, wherein the component b is selected from the following: a dimethylhydrogensiloxy modified silica (for example, CAS: 102262-28-2), a hydride modified silica Q resin (for example, HQM-105 (CAS: 68988-57-8), trimethyl terminated dimethyl-co-hydrogen methyl polysiloxane (for example, CAS: 68037-59-2), tris(dimethyl-silyloxy)-phenylsilane (for example. CAS: 18027-45-7), methyltris(dimethyl-siloxy)silane (for example, CAS: 17082-46-1), 1,3,5,7-tetramethyl-cyclotetrasiloxane (for example, CAS: 2370-88-9), tetrakis(dimethylsiloxy)silane (for example, CAS: 17082-47-2), 1,1,3,3,5,5-hexamethyltrisiloxane (for example, CAS: 1189-93-1), 1,1,3,3-tetramethyl-disiloxane (CAS: 3277-26-7), phenylsilsesquioxanes, hydrogen-terminated (for example, CAS: 68952-30-7), 1,1,1,3,5,5,5-heptamethyltrisiloxane, 1,1,3,3-tetramethyldisiloxane, 3-((dimethylsilyl)oxy)-1,1,5,5-tetramethyl-3-phenyltrisiloxane, triethoxysilane, or 1-(2-(trimethoxysilyl)ethyl)-1,1,3,3-tetramethyldisiloxane, or an SiH terminated PDMS; and further from 1,1,1,3,5,5,5-heptamethyltrisiloxane, 1,1,3,3-tetramethyldisiloxane, 3-((dimethylsilyl)oxy)-1,1,5,5-tetramethyl-3-phenyltrisiloxane, triethoxysilane, or 1-(2-(trimethoxysilyl)ethyl)-1,1,3,3-tetramethyldisiloxane, or an SiH terminated PDMS, and further from 1,1,1,3,5,5,5-heptamethyltrisiloxane, 1,1,3,3-tetramethyldisiloxane, 3-((dimethylsilyl)oxy)-1,1,5,5-tetramethyl-3-phenyltrisiloxane, triethoxysilane, or 1-(2-(trimethoxysilyl)ethyl)-1,1,3,3-tetramethyldisiloxane.
Q2] The process of any one of A]-O2] above, wherein the component b is selected from structures (s1) through (s16) as shown above.
R2] The process of any one of A]-Q2] above, wherein the composition is thermally treated at a temperature ≥120° C., or ≥130° C., or ≥140° C., or ≥150° C.
S2] The process of any one of A]-R2] above, wherein the composition is thermally treated at a temperature ≤200° C., or ≤19020 C., or ≤180° C., or ≤170° C., or ≤160° C.
T2] The process of any one of A]-S2] above, wherein the composition has a percent decrease in T90 ≥2.0%, or ≥5.0%, or ≥6.0%, or ≥7.0%, or ≥8.0%, or ≥9.0%, or ≥10%, or ≥12%, or ≥14%, or ≥16%, as compared to a “similar composition” that does not contain component b, but contains a weight increase in component a equal to the amount of component b in the composition. For example, see Table 10 (Comp. G and Inv. 14-Inv. 16).
U2] The process of any one of A]-T2] above, wherein the composition has a percent decrease in T90 ≤50%, or ≤45%, ≤40%, or ≤35%, or ≤30%, or ≤28%, or ≤26%, as compared to a “similar composition” that does not contain component b, but contains a weight increase in component a equal to the amount of component b in the composition.
V2] The process of any one of A]-U2] above, wherein the composition has a percent increase in MH ≥2.0%, or ≥3.0%, or ≥4.0%, or ≥5.0%, or ≥6.0%, or ≥8.0%, or ≥10%, or ≥15%, or ≥20%, or ≥25%, or ≥30% or ≥35%, or ≥40%, or ≥45%, or ≥50%, or ≥60%, ≥70%, or ≥80% or ≥90%, or ≥100%, as compared to a “similar composition” that does not contain component b, but contains a weight increase in component a equal to the amount of component b in the composition.
W2] The process of any one of A]-V2] above, wherein the composition has a percent increase in MH ≤300%, or ≤280%, or ≤260%, or ≤240%, or ≤220%, as compared to a “similar composition” that does not contain component b, but contains a weight increase in component a equal to the amount of component b in the composition.
X2] A crosslinked composition formed from the process of any one of A]-W2].
A3] A composition comprising at least the following components:
a) an elastomer, or an olefin-based polymer that has a density >0.920 g/cc, and wherein component a has a total unsaturation ≥0.20/1000 C;
b) a molecule comprising at least one Si—H group;
c) at least one peroxide; and
d) optionally, at least one crosslinking coagent different from component b.
B3] A composition comprising at least the following components a and b:
a) an elastomer that has a total unsaturation ≥0.20/1000 C, or an olefin-based polymer that has a density >0.920 g/cc and a total unsaturation ≥0.20 /1000 C, and wherein the elastomer is selected from the following:
   i) a telechelic polyolefin of the formula A¹L¹L²A²,
   ii) an ethylene/alpha-olefin/nonconjugated polyene interpolymer that has a Mooney Viscosity (ML1+4 at 125° C.) from 5 to 30,
   iii) an ethylene/alpha-olefin copolymer, or
   iv) an unsaturated polyolefin of the formula A¹L¹;
b) a molecule comprising at least one Si—H group.
C3] The composition of A3] or B3] above, wherein component a has a total unsaturation ≥0.25/1000 C, or ≥0.30/1000 C, or ≥0.35/1000 C, or ≥0.40/1000 C, or ≥0.45/1000 C, or ≥0.50/1000 C ≥0.55/1000 C, or ≥0.60/1000 C, or ≥0.65/1000 C, or ≥0.70/1000 C, or ≥0.75/1000 C, or ≥0.80/1000 C, or ≥0.85/1000 C. or ≥0.90/1000 C, or ≥0.95/1000 C, or ≥1.00/1000 C, and/or ≤15.0/1000 C, or ≤10.0/1000 C, or ≤5.00/1000 C, or ≤2.00/1000 C, or ≤1.50/1000 C.
D3] The composition of any one of A3]-C3] above, wherein component a is an elastomer.
E3] The composition of any one of A3]-D3] above, wherein the elastomer (component a) has a density ≥0.860, or ≥0.862, or ≥0.864, or ≥0.866, or ≥0.868, or ≥0.870 g/cc (1 cc=1 cm³).
F3] The composition of any one of A3]-E3] above, wherein the elastomer (component a) has a density ≤0.920, or ≤0.915, or ≤0.910, or ≤0.905, or ≤0.900, or ≤0.895, or ≤0.890, or ≤0.885, or ≤0.880 g/cc.
G3] The composition of any one of A3]-F3] above, wherein the elastomer is selected from a telechelic polyolefin of the formula A¹L¹L²A², an unsaturated polyolefin of the formula ALL', an ethylene/alpha-olefin/nonconjugated polyene interpolymer, or an ethylene/alpha-olefin interpolymer.
H3] The composition of any one of A3]-G3] above, wherein the elastomer is a telechelic polyolefin of the formula A¹L¹L²A²; wherein L¹ is an ethylene-based polymer, further an ethylene/alpha-olefin interpolymer, and further a telechelic ethylene/alpha-olefin copolymer.
I3] The composition of H3] above, wherein the alpha-olefin is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
J3] The composition of H3] or I3] above, wherein the telechelic polyolefin of the formula A¹L¹L²A² has a has a melt index (I2) ≥0.5 dg/min, or ≥1.0 dg/min, or ≥2.0 dg/min, or ≥5.0 dg/min, or ≥10 dg/min, or ≥12 dg/min, or ≥15 dg/min, or ≥18 dg/min, or ≥20 dg/min.
K3] The composition of any one of H3-J3] above, wherein the telechelic polyolefin of the formula A¹L¹L²A² has a melt index (I2) ≤100 dg/min, or ≤90 dg/min, or ≤80 dg/min, or ≤70 dg/min, or ≤60 dg/min, or ≤50 dg/min, or ≤40 dg/min, or ≤35 dg/min.
L³] The composition of any one of A3]-G3] above, wherein the elastomer is an unsaturated polyolefin of the formula A¹L¹; wherein L¹ is an ethylene-based polymer, further an ethylene/alpha-olefin interpolymer, and further an ethylene/alpha-olefin copolymer.
M3] The composition of L3] above, wherein the alpha-olefin is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
N3] The composition of L3] or M3] above, wherein the unsaturated polyolefin of the formula A¹L¹ has a has a melt index (I2) ≥0.5 dg/min, or ≥0.8 dg/min, or ≥1.0 dg/min, or ≥2.0 dg/min, or ≥5.0 dg/min, or ≥10 dg/min.
O3] The composition of any one of L3]-N3] above, wherein the unsaturated polyolefin of the formula A¹L¹ has a melt index (I2) ≤100 dg/min, or ≤90 dg/min, or ≤80 dg/min, or ≤70 dg/min, or ≤60 dg/min, or ≤50 dg/min, or ≤40 dg/min.
P3] The composition of any one of A3]-G3] or B3]-G3] above, wherein the elastomer is an ethylene/alpha-olefin/non-conjugated polyene interpolymer, further an ethylene/alpha-olefin/nonconjugated diene interpolymer, and further an ethylene/alpha-olefin/nonconjugated diene terpolymer, further an EPDM.
Q3] The composition of P3] above, wherein the ethylene/alpha-olefin/nonconjugated polyene interpolymer has a Mooney Viscosity (ML1+4 at 125° C.) ≥5, or ≥10, or ≥12, or ≥14, or ≥16, or ≥18.
R3] The composition of P3] or Q3] above, wherein the ethylene/alpha-olefin/non-conjugated polyene interpolymer has a Mooney Viscosity (ML1+4 at 125° C.) ≤50, or ≤40, or ≤35, or ≤30, or ≤25, or ≤22, or ≤20.
S3] The composition of any one of P3] or Q3] above, wherein the ethylene/alpha-olefin/nonconjugated polyene interpolymer has a Mooney Viscosity (ML1+4 at 125° C.) ≤30, or ≤25, or ≤20.
T3] The composition of any one of A3]-G3] above, wherein the elastomer is an ethylene/alpha-olefin interpolymer, and further an ethylene/alpha-olefin copolymer.
U3] The composition of T3] above, wherein the alpha-olefin is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
V3] The composition of T3] or U3] above, wherein the ethylene/alpha-olefin interpolymer has a has a melt index (I2) ≥0.5 dg/min, or ≥1.0 dg/min, or ≥2.0 dg/min, or ≥5.0 dg/min, or ≥10 dg/min, or ≥15 dg/min, or ≥20 dg/min.
W3] The composition of any one of T3]-V3] above, wherein the ethylene/olefin interpolymer has a melt index (I2) ≤100 dg/min, or ≤90 dg/min, or ≤80 dg/min, or ≤75 dg/min or ≤70 dg/min, or ≤65 dg/min, or ≤60 dg/min, or ≤55 dg/min, or ≤50 dg/min, or ≤45 dg/min or ≤40 dg/min, or ≤35 dg/min or ≤30 dg/min.
X3] The composition of any one of A3]-C3] above, wherein component a is an olefin-based polymer that has a density >0.920 g/cc, further an ethylene-based polymer, further an ethylene/alpha-olefin interpolymer, and further an ethylene/alpha-olefin copolymer.
Y3] The composition of X3] above, wherein the alpha-olefin is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
Z3] The composition of X3] or Y3] above, wherein the olefin-based polymer (component a) has a density ≥0.925, or ≥0.930, or ≥0.935, or ≥0.940 g/cc (1 cc=1 cm³).
A4] The composition of any one of X3]-Z3] above, wherein the olefin-based polymer (component a) has a density ≤0.960, or ≤0.955, or ≤0.950, or ≤0.945 g/cc.
B4] The composition of any one of X3]-A4] above, wherein the olefin-based polymer has a melt index (I2) ≥0.5 dg/min, or ≥0.8 dg/min, or ≥1.0 dg/min, or ≥2.0 dg/min, or ≥5.0 dg/min, or ≥10 dg/min.
C4] The composition of any one of X3]-B4] above, wherein the olefin-based polymer has a melt index (I2) ≤100 dg/min, or ≤90 dg/min, or ≤80 dg/min, or ≤70 dg/min, or ≤60 dg/min, or ≤50 dg/min, or ≤40 dg/min.
D4] The composition of any one of A3]-C4] above, wherein the component b comprises ≥2, or ≥3 Si—H groups.
E4] The composition of any one of A3]-D4] above, wherein the component b comprises ≥1, or ≥2, or ≥3 siloxane groups (—Si—O—Si—).
F4] The composition of any one of A3]-E4] above, wherein the component b comprises a —CR¹═CH₂ group, where R¹ is H or an alkyl.
G4] The composition of any one of A3]-F4] above, wherein the component b does not comprise a carbonyl group [—C(O)—] or a carboxyl group [—C(O)O—].
H4] The composition of any one of A3]-G4] above, wherein the silicon of the SiH in component b is bonded to at least one alkyl group (R).
I4] The composition of any one of A3]-H4] above, wherein the silicon of the SiH in component b is bonded to at least one alkoxyl group (RO), where R=alkyl.
J4] The composition of any one of A3]-14] above, wherein the silicon of the SiH in component b is bonded to at least one Si—O group.
K4] The composition of any one of A3]-J4] above, wherein component b comprises an alkoxyl silane (R—O—Si) group, in addition to at least one Si—H group, where R=alkyl.
L4] The composition of any one of A3]-K4] above, wherein component b comprises one or more double bonds.
M4] The composition of any one of A3]-L4] above, wherein the component b comprises ≥20 wt %, or ≥22 wt %, or ≥24 wt %, or ≥26 wt %, or ≥28 wt %, or ≥30 wt %, or ≥32 wt % of Si, based on the weight of the molecule.
N4] The composition of any one of A3]-M4] above, wherein the component b comprises ≤60 wt %, or ≤55 wt %, or ≤50 wt %, or ≤48 wt %, or <46 wt %, or ≤44 wt %, or ≤42 wt % of Si, based on the weight of the molecule.
O4] The composition of any one of A3]-N4] above, wherein the component b has a weight ratio of Si to O ≥1.0, or ≥1.2, or ≥1.5, or ≥2.0, or ≥2.2, or ≥2.4, or ≥2.6, or ≥3.0.
P4] The composition of any one of A3]-04] above, wherein the component b has a weight ratio of Si to O ≤5.0, or ≤4.8, or ≤4.6, or ≤4.4, or ≤4.2, or ≤4.0, or ≤3.8 of Si, based on the weight of the molecule.
Q4] The composition of any one of A3]-P4] above, wherein the component b is selected from the following: a dimethylhydrogensiloxy modified silica (for example, CAS: 102262-28-2), a hydride modified silica Q resin (for example, HQM-105 (CAS: 68988-57-8), trimethyl terminated dimethyl-co-hydrogen methyl polysiloxane (for example, CAS: 68037-59-2), tris(dimethyl-silyloxy)-phenylsilane (for example. CAS: 18027-45-7), methyltris(dimethyl-siloxy)silane (for example, CAS: 17082-46-1), 1,3,5,7-tetramethyl-cyclotetrasiloxane (for example, CAS: 2370-88-9), tetrakis(dimethylsiloxy)-silane (for example, CAS: 17082-47-2), 1,1,3,3,5,5-Hexamethyltrisiloxane (for example, CAS: 1189-93-1), 1,1,3,3-tetramethyl-disiloxane (CAS: 3277-26-7), phenylsilsesquioxanes, hydrogen-terminated (for example, CAS: 68952-30-7), 1,1,1,3,5,5,5-heptamethyltrisiloxane, 1,1,3,3-tetramethyldisiloxane, 3-((dimethylsilyl)oxy)-1,1,5,5-tetramethyl-3-phenyltrisiloxane, triethoxysilane, or 1-(2-(trimethoxysilyl)ethyl)-1,1,3,3-tetramethyldisiloxane, or an SiH terminated PDMS; and further from 1,1,1,3,5,5,5-heptamethyltrisiloxane, 1,1,3,3-tetramethyldisiloxane, 3-((dimethylsilyl)oxy)-1,1,5,5-tetramethyl-3-phenyltrisiloxane, triethoxysilane, or 1-(2-(trimethoxysilyl)ethyl)-1,1,3,3-tetramethyldisiloxane, or an SiH terminated PDMS, and further from 1,1,1,3,5,5,5-heptamethyltrisiloxane, 1,1,3,3-tetramethyldisiloxane, 3-((dimethylsilyl)oxy)-1, 1,5,5-tetramethyl-3-phenyltrisiloxane, triethoxysilane, or 1-(2-(trimethoxysilyl)ethyl)-1,1,3,3-tetramethyldisiloxane.
R4] The composition of any one of A3]-P4] above, wherein the component b is selected from structures (s1) through (s16) as shown above.
S4] The composition of any one of A3]-R4] above, wherein the composition has a percent decrease in T90 ≥2.0%, or ≥5.0%, or ≥6.0%, or ≥7.0%, or ≥8.0%, or ≥9.0%, or ≥10%, or ≥12%, or ≥14%, or ≥16%, as compared to a “similar composition” that does not contain component b, but contains a weight increase in component a equal to the amount of component b in the composition.
T4] The composition of any one of A3]-S4] above, wherein the composition has a percent decrease in T90 ≤50%, or ≤45%, ≤40%, or ≤35%, or ≤30%, or ≤28%, or ≤26%, as compared to a “similar composition” that does not contain component b, but contains a weight increase in component a equal to the amount of component b in the composition.
U4] The composition of any one of A3]-T4] above, wherein the composition has a percent increase in MH ≥2.0%, or ≥3.0%, or ≥4.0%, or ≥5.0%, or ≥6.0%, or ≥8.0%, or ≥10%, or ≥15%, or ≥20%, ≥25%, or ≥30% or ≥35%, or ≥40%, or ≥45%, or ≅50%, or ≥60%, ≥70%, or ≥80% or ≥90%, or ≥100%, as compared to a “similar composition” that does not contain component b, but contains a weight increase in component a equal to the amount of component b in the composition.
V4] The composition of any one of A3]-U4] above, wherein the composition has a percent increase in MH ≤300%, or ≤280%, or ≤260%, or ≤240%, or ≤220%, as compared to a “similar composition” that does not contain component b, but contains a weight increase in component a equal to the amount of component b in the composition.
W4] The process of any one of A]-W2] above, or the composition of any one of A3]-V4] above, wherein the composition comprises ≥90.0 wt %, or ≥92.0 wt %, or ≥94.0 wt %, or ≥96.0 wt %, or ≥97.0 wt % or ≥98.0 wt % of component a based on the weight of the composition.
X4] The process of any one of A]-W2] or W4] above, or the composition of any one of A3]-W4] above, wherein the composition comprises ≤100.0 wt %, or ≤99.8 wt %, or ≤99.6 wt %, or ≤99.4 wt %, or ≤99.2 wt %, or ≤99.0 wt % of component a based on the weight of the composition.
Y4] The process of any one of A]-W2] or W4] or X4] above, or the composition of any one of A3]-X4] above, wherein the weight ratio of component a to component bis ≥10, or ≥12, or ≥14, or ≥16, or ≥18, or ≥20, or ≥25, or ≥30.

Z4] The process of any one of A]-W2] or W4]-Y4] above, or the composition of any one of A3]-Y4] above, wherein the weight ratio of component a to component bis ≤2000, or ≤1800, or ≤1600, or ≤1400, or ≤1200, or ≤1000, or ≤800, or ≤600, or ≤400, or ≤200, or ≤100, or ≤50.
A5] The process of any one of A]-W2] or W4]-Z4] above, or the composition of any one of A3]-Z4] above, wherein the composition comprises ≥0.02 wt %, or ≥0.05 wt %, or ≥0.06 wt %, or ≥0.07 wt %, or ≥0.08 wt %, or ≥0.10 wt %, or ≥0.12 wt %, or ≥0.14 wt %, or ≥0.16 wt %, or ≥0.18 wt %, or >0.20 wt % of component b based on the weight of the composition.
B5] The process of any one of A]-W2] or W4]-A5] above, or the composition of any one of A3]-A5] above, wherein the composition comprises ≤5.0 wt %, or ≤4.5 wt %, or ≤4.0 wt %, ≤3.5 wt %, or ≤3.0 wt %, or ≤2.5 wt %, or ≤2.0 wt %, or ≤1.5 wt %, or ≤1.0 wt % of component b based on the weight of the composition.
C5] The process of any one of A]-W2] or W4]-B5] above, or the composition of any one of A3]-B5] above, wherein the composition comprises component c, and further comprises ≥0.10 wt %, or ≥0.15 wt %, or ≥0.20 wt %, or ≥0.30 wt %, or ≥0.40 wt %, or ≥0.50 wt %, or ≥0.60 wt %, or ≥0.70 wt % of component c based on the weight of the composition. Component c is described above.
D5] The process of any one of A]-W2] or W4]-C5] above, or the composition of any one of A3]-C5] above, wherein the composition comprises component c, and further comprises ≤3.0 wt %, or ≤2.5 wt %, or ≤2.0 wt %, or ≤1.9 wt %, or ≤1.8 wt %, ≤1.7 wt %, or ≤1.6 wt %, or ≤1.5 wt %, or 1.4 wt %, or ≤1.2 wt % of component c, based on the weight of the composition.
E5] The process of any one of A]-W2] or W4]-D5] above, or the composition of any one of A3]-D5] above, wherein the composition comprises component d, and further comprises ≥0.10 wt %, or ≥0.15 wt %, or ≥0.20 wt % of component d based on the weight of the composition. Component d is described above.
F5] The process of any one of A]-W2] or W4]-E5] above, or the composition of any one of A3]-E5] above, wherein the composition comprises component d, and further comprises ≤1.0 wt %, or <0.8 wt %, or ≤0.6 wt % of component d, based on the weight of the composition.
G5] The process of any one of A]-W2] or W4]-F5] above, or the composition of any one of A3]-F5] above, wherein the composition comprises component c, and further weight ratio of component c to component bis ≥0.10, or ≥0.20, or ≥0.40, or ≥0.60, or ≥0.80, or ≥1.00, or ≥1.20.
H5] The process of any one of A]-W2] or W4]-G5] above, or the composition of any one of A3]-G5] above, wherein the composition comprises component c, and further the weight ratio of component c to component b is ≤50, or ≤45, or ≤40, or ≤35, or ≤30, or ≤25, or ≤20, or ≤15, or ≤10, or ≤8.0.
I5] The process of any one of A]-W2] or W4]-H5] above, or the composition of any one of A3]-H5] above, wherein the composition comprises component c, and further the weight ratio of component a to component c is ≥10, or ≥15, or ≥20, or ≥25, or ≥30, or ≥35, or ≥40, or ≥45.
J5] The process of any one of A]-W2] or W4]-I5] above, or the composition of any one of A3]-I5] above, wherein the composition comprises component c, and further the weight ratio of component a to component c is ≤600, or ≤500, or ≤400, or ≤300, or ≤200, or ≤180, or ≤160, or ≤140, or ≤120, or ≤100.
K5] The process of any one of A]-W2] or W4]-J5] above, or the composition of any one of A3]-J5] above, wherein the composition comprises component c and component d, and further the weight ratio of component c to component d is ≥0.10, or ≥0.15, or ≥0.20, or ≥0.25, or ≥0.30, or ≥0.35, or ≥0.40, or ≥0.45, or ≥0.50, or ≥0.60, or ≥0.70, or ≥0.80, or ≥0.90, or ≥1.0.
L5] The process of any one of A]-W2] or W4]-K5] above, or the composition of any one of A3]-K5] above, wherein the composition comprises component c and component d, and further the weight ratio of component c to component d is ≤20, or ≤15, or ≤10, or ≤8.0, or ≤6.0, or ≤4.0, or ≤2.0.
M5] The process of any one of A]-W2] or W4]-L5] above, or the composition of any one of A3]-L5] above, wherein the composition comprises ≥10.0 wt %, or ≥20.0 wt %, or ≥30.0 wt %, or ≥40.0 wt %, or ≥50.0 wt %, or ≥60.0 wt %, or ≥70.0 wt %, or ≥80.0 wt %, or ≥90.0 wt % of the sum of components a and b, based on the weight of the composition.
N5] The process of any one of A]-W2] or W4]-M5] above, or the composition of any one of A3]-M5] above, wherein the composition comprises ≤99.9 wt %, or ≤99.8 wt %, or ≤99.6 wt %, or ≤99.4 wt %, or ≤99.2 wt %, or ≤99.0 wt %, or ≤98.5 wt %, or ≤98.0 wt %, or ≤97.5 wt %, or ≤97.0 wt %, or ≤96.5 wt %, or ≤96.0 wt % of the sum of components a and b, based on the weight of the composition.
O5] The process of any one of A]-W2] or W4]-N5] above, or the composition of any one of A3]-N5] above, wherein the composition comprises component c, and further comprises ≥20.0 wt %, or ≥30.0 wt %, or ≥40.0 wt %, or ≥50.0 wt %, or ≥60.0 wt %, or ≥70.0 wt %, or ≥80.0 wt %, or ≥90.0 wt %, or ≥95.0 wt % of the sum of components a, b and c, based on the weight of the composition.
P5] The process of any one of A]-W2] or W4]-O5] above, or the composition of any one of A3]-O5] above, wherein the composition comprises component c, and further comprises ≤100.0 wt %, or ≤99.5 wt %, or ≤99.0 wt %, or ≤98.5.0 wt %, or ≤98.0 wt %, or ≤97.5 wt %, or ≤97.0 wt %, or ≤96.5 wt %, or ≤96.0 wt %, or ≤95.5 wt %, or ≤95.0 wt % of the sum of components a, b and c, based on the weight of the composition.
Q5] The process of any one of A]-W2] or W4]-P5] above, or the composition of any one of A3]-P5] above, wherein the composition has a [Mn×(Total Unsat/1000 C)] value ≥5.0, or ≥10, or ≥11, or ≥12, ≥13, or ≥14, or ≥15 kg/mol.
R5] The process of any one of A]-W2] or W4]-Q5] above, or the composition of any one of A3]-Q5] above, wherein the composition has a [Mn×(Total Unsat/1000 C)] value ≤50, or ≤48, or ≤45, or ≤43, or ≤40, or ≤38, or ≤35, or ≤33, or ≤30, or ≤28, or ≤25, or ≤23 kg/mol.
S5] The process of any one of A]-W2] or W4]-R5] above, or the composition of any one of A3]-R5] above, wherein component a has a molecular weight distribution MWD (=Mw/Mn) ≥1.80, or ≥1.90, or ≥2.00, or ≥2.10, or ≥2.15, or ≥2.20, or ≥2.25, or ≥2.30, and/or ≤5.00, or ≤4.80, or ≤4.50, or ≤4.30, or ≤4.00 or ≤4.00, or ≤3.80, or ≤3.60, or ≤3.40 or ≤3.20, or ≤3.00, or ≤2.80.
T5] The process of any one of A]-W2] or W4]-S5] above, or the composition of any one of A3]-S5] above, wherein component a has a number average molecular weight Mn ≥5,000, or ≥8,000, or ≥10,000, or ≥12,000, or ≥14,000, or ≥16,000, or ≥18,000, or ≥20,000 g/mol, and/or ≤100,000, or ≤90,000, or ≤80,000, or ≤70,000, or ≤65,000, or ≤60,000, or ≤55,000, or ≤50,000, or ≤45,000, or ≤40,000 g/mol.
U5] The process of any one of A]-W2] or W4]-T5] above, or the composition of any one of A3]-T5] above wherein component a has a % vinyl ≥2.0%, or ≥4.0%, or ≥6.0%, or ≥8.0%, or ≥10%, or ≥15%, or ≥20%, or ≥25%, or ≥30%, or >35%, or ≥40%, and/or ≤90%, or ≤85%, or ≤80%, or ≤78%, or ≤76%, or ≤74%, or ≤72%, or ≤70%, where % vinyl=[(vinyl/1000 C)/(total unsaturation/1000 C)]×100.
V5] The process of any one of A]-W2] or W4]-U5] above, or the composition of any one of A3]-U5] above wherein component a has a vinyl content ≥0.02/1000 C, or ≥0.04/1000 C, or ≥0.06/1000 C, or ≥0.08/1000 C, or ≥0.10/1000 C, or ≥0.12/1000 C, or ≥0.14/1000 C, or ≥0.16/1000 C, or ≥0.18/1000 C, or ≥0.20/1000 C, or ≥0.22/1000 C, and/or ≤1.0/1000 C, or ≤0.80/1000 C, or ≤0.70/1000 C, or ≤0.60/1000 C, or ≤0.55/1000 C, or ≤0.50/1000 C, or ≤0.48/1000 C.
W5] The process of any one of A]-W2] or W4]-V5] above, or the composition of any one of A3]-V5] above, wherein component a has a sum of vinyl and vinylidene content ≥0.08/1000 C, or ≥0.10/1000 C, or ≥0.12/1000 C, or ≥0.14/1000 C, or ≥0.16/1000 C, or ≥0.18/1000 C, or ≥0.20/1000 C, or ≥0.22/1000 C, or ≥0.25/1000 C, or ≥0.27/1000 C, or ≥0.30/1000 C, or ≥0.32/1000 C, or ≥0.35/1000 C, or ≥0.37/1000 C, or ≥0.40/1000 C, or ≥0.42/1000 C, or ≥0.45/1000 C, or ≥0.47/1000 C, or ≥0.50/1000 C, or ≥0.52/1000 C, and/or ≤1.00/1000 C, or ≤0.95/1000 C, or ≤0.90/1000 C, or ≤0.85/1000 C, or ≤0.80/1000 C, or ≤0.75/1000 C, or ≤0.70/1000 C, or ≤0.65/1000 C, or ≤0.60/1000 C.
X5] The process of any one of A]-W2] or W4]-W5] above, or the composition of any one of A3]-W5] above, wherein component a has a % vinylidene ≥2.0%, or ≥4.0%, or ≥6.0%, or ≥8.0%, or ≥10%, or ≥12%, or ≥14%, or ≥16%, and/or ≤60%, or ≤50%, or ≤40%, or ≤35%, or ≤30%, or ≤28%, where % vinylidene=[(vinylidene/1000 C)/(total unsaturation/1000C)]×100.
Y5] A crosslinked composition formed the composition of any one of A3]-X5] above.
Z5] A crosslinked composition formed the process of any one of W4]-X5] above.
A6] An article comprising at least one component formed from the composition of any one of X2] or A3]-X5] above.
B6] The article of A6] above, wherein the article is a film, or a foam, and further a film.
C6] The article of A6] above, wherein the article is a solar cell module, a wire or cable, a footwear component, an automotive part, a window profile, a tire, a tube/hose, or a roofing membrane, and further a solar cell module, a wire or cable, a footwear component, an automotive part, and further a solar cell module.
D6] The article of A6] above, wherein the article is an encapsulation film for a solar cell module.
E6] The article of A6] above, wherein the article is a solar cell module comprising a front transparent surface protective layer, a front crosslinked encapsulation film, a solar cell element, a back crosslinked encapsulation film, and a back transparent surface protective layer.
F6] A lamination process to prepare a solar cell module; said process comprising crosslinking a film formed from the composition of any one of A3]-X5].
G6] A process to form a crosslinked composition, said process comprising thermally treating the composition of any one of A3]-X5] above.

### TEST METHODS

### MDR Test

Cure characteristics were measured using an Alpha Technologies Moving Die Rheometer (MDR) 2000, according to ASTM D5289, with a 0.5 deg arc on the pellets, which were stored for 24 hours at RT (room temp.) in bottle after soaking. For each composition, the MDR was loaded with approximately 4.5 g of pellets. The MDR was run for 25 minutes, at 150° C., and the “time versus torque” profile was generated over the given interval. The following data were used from each MDR run: MH (dNm), or the maximum torque exerted by the MDR during the 25 minute testing interval (this usually corresponds to the torque exerted at 25-minute time point); ML (dNm), or the minimum torque exerted by the MDR during the 25 minute testing interval (this usually corresponds to the torque exerted at the beginning of the test interval); and T90 (time it takes to reach 90% of the (MH-ML) value).

### ¹H NMR Method

Sample Preparation: Each sample was prepared by adding approximately 130 mg of sample to 3.25 g of a “50/50 by weight tetrachlorethane-d2/perchloroethylene (TCE-d2/PCE) with 0.001M Cr(AcAc)₃,” in a NORELL 1001-7, 10 mm, NMR tube. The sample was purged by bubbling N₂ through the solvent, via a pipette inserted into the tube, for approximately five minutes to prevent oxidation. The tube was then capped and sealed with TEFLON tape, before heating and vortex mixing at 115° C. to achieve a homogeneous solution.

Data Acquisition Parameters and Data Analysis: ¹H NMR was performed on a Bruker AVANCE 600 MHz spectrometer, equipped with a Bruker high-temperature CryoProbe, with a sample temperature of 120° C. Two experiments were run to obtain spectra, a control spectrum to quantitate the total polymer protons, and a double presaturation experiment, which suppresses the intense peaks associated with the polymer chains, and enables high sensitivity spectra for quantitation of the end-groups. The control was run with ZG pulse, 16 scans, AQ 1.82 s, D₁ (relaxation delay) 14 s. The double presaturation experiment was run with a modified pulse sequence, lclprf2.zz, 64 scans, AQ 1.82 s, D₁ (presaturation time) 2 s, D₁₃ (relaxation delay) 12 s. Unsaturation measurements were made according to the following method. The area under the resonance from the polymer chains (i.e., CH, CH₂, and CH₃ in the polymers) was measured from the spectrum acquired during first experiment (the control spectrum), described above.

The unsaturation was analyzed with the method in Reference 3 noted below. Reference 1: Z. Zhou, R. Kuemmerle, J. C. Stevens, D. Redwine, Y. He, X. Qiu, R. Cong, J. Klosin, N. Montañez, G. Roof, Journal of Magnetic Resonance, 2009, 200, 328. Reference 2: Z. Zhou, R. Kummerle, X. Qiu, D. Redwine, R. Cong. A. Taha, D. Baugh, B. Winniford, Journal of Magnetic Resonance: 187 (2007) 225. Reference 3: Z. Zhou, R. Cong, Y. He, M. Paradkar, M. Demirors, M. Cheatham, W. deGroot, Macromolecular Symposia, 2012, 312, 88.

The peak areas for each type of observed unsaturation (i.e., vinyl, vinylidene, vinylene, trisubstituted, cyclohexene, and etbylidene norbornene (ENB) endo and exo isomers from EPDM unsaturation) was measured from the spectrum acquired during the second (presaturation) experiment described above. In the case of EPDM spectra, overlapping peak areas are compensated appropriately. Both spectra were normalized to the solvent peak area. Moles of respective unsaturation were calculated by dividing the area under the unsaturation resonance by the number of protons contributing to that resonance. Moles of carbons in the polymers were calculated by dividing the area under the peaks for polymer chains (i.e., CH, CH₂, and CH₃ in the polymers) by two. The amount of total unsaturation (sum of the above unsaturations) was then expressed as a relative ratio of moles of total unsaturation to the moles of carbons in the polymers, with expression of the number of unsaturation per 1000 Carbon (per 1000 C). Note that the results for EPDM samples in TCE-d2/PCE can be calculated from spectra acquired using 1,4-orthodichlorobenzene-d4/PCE, to eliminate the TCE peak interference with the single vinyl proton at about 5.9 ppm. Results are the same within <5% relative.

### Melt Index

The melt index I2 (or MI) of an ethylene-based polymer was measured in accordance with ASTM D-1238, condition 190° C./2.16 kg. The melt flow rate MFR of a propylene-based polymer is measured in accordance with ASTM D-1238, condition 230° C./2.16 kg.

### Polymer Density

ASTM D4703 was used to make a polymer plaque for density analysis. ASTM D792, Method B, was used to measure the density of each polymer.

### Mooney Viscosity of Polymer (No Oil, No Filler)

Mooney Viscosity (ML1+4 at 125° C.) was measured in accordance with ASTM 1646, with a one minute preheat time and a “four minute” rotor operation time. The instrument was an Alpha Technologies Mooney Viscometer 2000. Sample size around 25 grams.

### Gel Permeation Chromatography—Ethylene-Based Polymers

The chromatographic system consists of a PolymerChar GPC-IR (Valencia, Spain) high temperature GPC chromatograph, equipped with an internal infra-red detector (IR5). The autosampler oven compartment is set at 160° C., and the column compartment is set at 150° C. The columns are four AGILENT “Mixed A” 30 cm, 20-micron linear mixed-bed columns. The chromatographic solvent is 1,2,4-trichlorobenzene, which contains 200 ppm of butylated hydroxytoluene (BHT). The solvent source is nitrogen sparged. The injection volume is 200 microliters, and the flow rate is 1.0 milliliters/minute.

Calibration of the GPC column set is performed with 21 narrow molecular weight distribution polystyrene standards, with molecular weights ranging from 580 to 8,400,000 g/mol, and which are arranged in six “cocktail” mixtures, with at least a decade of separation between individual molecular weights. The standards are purchased from Agilent Technologies. The polystyrene standards are prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards are dissolved at 80° C., with gentle agitation, for 30 minutes. The polystyrene standard peak molecular weights are converted to polyethylene molecular weights using Equation 1 (as described in Williams and Ward, J. Polym. Sci., Polym. Let., 6, 621 (1968)):

M_{polyethylene}=A×(Mpolystyrene)^{B} (EQ1),

where M is the molecular weight, A has a value of 0.4315 and B is equal to 1.0.

A fifth order polynomial is used to fit the respective polyethylene-equivalent calibration points. A small adjustment to A (from approximately 0.375 to 0.445) is made to correct for column resolution and band-broadening effects, such that linear homopolymer polyethylene standard is obtained at 120,000 Mw.

The total plate count of the GPC column set is performed with decane (prepared at “0.04 g in 50 milliliters” of TCB, and dissolved for 20 minutes with gentle agitation.) The plate count (Equation 2) and symmetry (Equation 3) are measured on a 200 microliter injection according to the following equations:

$$Plate Count = 5.54 * {( \frac{( {RV}_{Peak Max}}{Peak Width at \frac{1}{2} height} )}^{2} , \qquad ( EQ2 )$$

where RV is the retention volume in milliliters, the peak width is in milliliters, the peak max is the maximum height of the peak, and ½ height is ½ height of the peak maximum; and

$$Symmetry = \frac{Rear Peak R {V}_{one tenth height} - R {V}_{Peak max}}{R {V}_{Peak max} - Front Peak R {V}_{one tenth height}} , \qquad ( EQ 3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples are prepared in a semi-automatic manner with the PolymerChar “Instrument Control” Software, wherein the samples are weight-targeted at “2 mg/ml,” and the solvent (contains 200 ppm BHT) is added to a pre nitrogen-sparged, septa-capped vial, via the PolymerChar high temperature autosampler. The samples are dissolved for two hours at 160° C. under “low speed” shaking.

The calculations of Mn_{(GPC)}, Mw_{(GPC)}, and Mz_{(GPC)} are based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( {IR}_{i} / {M}_{{polyethylene}_{i}} )} , \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} , \qquad ( EQ 5 )$$

$$and {Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} . \qquad ( EQ 6 )$$

In order to monitor the deviations over time, a flowrate marker (decane) is introduced into each sample, via a micropump controlled with the PolymerChar GPC-IR system. This flowrate marker (FM) is used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system, based on a flow marker peak, the effective flowrate (with respect to the narrow standards calibration) is calculated as Equation 7:

Flowrate(effective)=Flowrate(nominal)*(RV(FM Calibrated)/RV(FM Sample)) (EQ7).

Processing of the flow marker peak is done via the PolymerChar GPCOne™ M Software. Acceptable flowrate correction is such that the effective flowrate is within +/−0.7% of the nominal flowrate.

### EXPERIMENTAL

### Commercial Polymers and Additives

NORDEL 3720 P EPDM, Mooney viscosity=20 (ML 1+4, 125° C.), 0.5 wt % ENB, 69.5 wt % ethylene, available from The Dow Chemical Company.

NORDEL 3722P EPDM, Mooney viscosity=18 (ML 1+4, 125° C.), 0.5 wt % ENB, 70.5 wt % ethylene, available from The Dow Chemical Company.

ENGAGE PV 8669 Polyolefin Elastomer, density=0.873 g/cc, I2=14 dg/min, available from The Dow Chemical Company.

ENGAGE 8407 Polyolefin Elastomer, ethylene/1-octene copolymer: density=0.870 g/cc, I2=30 dg/min, available from The Dow Chemical Company.

EVA E282PV (ethylene vinyl acetate copolymer), density=0.948 g/cc, I2=25 dg/min, VA content 28 wt %, available from Hanwha.

Vinyl D4 (2,4,6,8-tetramethyltetravinylcyclotetrasiloxane (CAS: 2554-06-5)) available from the Dow Chemical Company.

TAIC (triallyl isocyanurate) available from Hunan Farida Technology, Co. Ltd..

TBEC (tert-butylperoxy-2-ethylhexyl carbonate [CAS: 34443-12-4]) available from Arkema.

TAEC (tert-amylperoxy 2-ethylhexyl carbonate [CAS: 70833-40-8]) available from Arkema.

CH-80MO (1,1-di(tert-butylperoxy)cyclohexane [CAS: 3006-86-8], 80%) available from Qiangsheng Chemical.

VMMS (3-(trimethoxysilyl)propylmethacrylate), available from The Dow Chemical Company.

SiH-1: 1,1,1,3,5,5,5-heptamethyltrisiloxane[CAS: 1873-88-7], available from TCI.

SiH-2: 1,1,3,3-tetramethyldisiloxane[CAS: 3277-26-7], available from TCI.

SiH-3: 3-((dimethylsilyl)oxy)-1,1,5,5-tetramethyl-3-phenyltrisiloxane [CAS: 18027-45-7], available from TCI.

SiH-PDMS: hydride terminated polydimethylsiloxane, viscosity of 7-10 mPa·s and 0.16 wt % SiH, commercially available as DMS-H11 from Gelest [CAS 70900-21-9].

SiH-4: triethoxysilane [CAS: 998-30-1], available from SCRC.

SiH-5: 1-(2-(trimethoxysilyl)ethyl)-1,1,3,3-tetramethyldisiloxane [CAS: 137407-65-9], available from Macklin Biochemical Company.

A summary of the elastomers used in the studies below is shown in Tables 1A through 1C.

TABLE 1A
Elastomers and EVA

| | | | MI (or I2) | Total Unsat/ |
|---|---|---|---|---|
| | | Density, | (2.16 kg. | 1000 C |
| | Type | g/cc | 190° C.), dg/min | (1H NMR) |
| ENGAGE 8407 | EO POE | 0.870 | 30 | 0.078 |
| ENGAGE PV 8669 | EO POE | 0.873 | 14 | 0.07 |
| NORDEL 3720 | EPDM | | 20 Mooney | 1.270 |
| NORDEL 3722 | EPDM | | 18 Mooney | 1.155 |
| EO Tele 1 | EO telechelic A¹L¹L²A² - | 0.873 | 27.3 | 1.078 |
| | TP6 from WO2020/140058 | | | |
| EO Mono 2 | EO monounsaturated A¹L¹ - | 0.873 | 30.8 | 0.562 |
| | MP3 from WO2020/140067 | | | |
| EO R06 | EO high unsaturation | 0.87 | 26.7 | 0.71 |
| E282PV EVA | 28 wt % VA | 0.948 | 25 | — |
| EO Mono 3 | EO monounsaturated A¹L¹ | 0.871 | 33.4 | 0.596 |
| EO Mono 4 | EO monounsaturated A¹L¹ | 0.868 | 1.1 | 0.294 |
| EO Mono 5 | EO monounsaturated A¹L¹ | 0.902 | 1.1 | 0.346 |

TABLE 1
B: Elastomers

| | | | | | | [Mn × (Total | Mn × (Total | |
|---|---|---|---|---|---|---|---|---|
| | | | | | | Unsat/ | Unsat/ | Total |
| | Mn | Mn | Mw | Mw | | 1000 C)] | 1000 C)] | Unsat/ |
| | (g/mol) | (kg/mol) | (g/mol) | (kg/mol) | MWD | (g/mol) | (kg/mol) | 1000 C |
| ENGAGE 8407 | 23100 | 23.1 | 49338 | 49.3 | 2.14 | 1802 | 1.8 | 0.078 |
| ENGAGE PV 8669 | 27071 | 27.1 | 57068 | 57.1 | 2.11 | 1895 | 1.9 | 0.07 |
| NORDEL 3720P | 33216 | 33.2 | 120240 | 120.2 | 3.62 | 42184 | 42.2 | 1.270 |
| NORDEL 3722P | 24414 | 24.4 | 103953 | 104.0 | 4.26 | 28198 | 28.2 | 1.155 |
| EO R06 | 27470 | 27.5 | 58107 | 58.1 | 2.12 | 19504 | 19.5 | 0.71 |
| EO Tele 1 | 19168 | 19.2 | 49262 | 49.3 | 2.57 | 20663 | 20.7 | 1.078 |
| EO Mono 2 | 18823 | 18.8 | 51010 | 51.0 | 2.71 | 10579 | 10.6 | 0.562 |
| EO Mono 3 | 21332 | 21.3 | 49277 | 49.3 | 2.31 | 12714 | 12.7 | 0.596 |
| EO Mono 4 | 53722 | 53.7 | 114965 | 115.0 | 2.14 | 15794 | 15.8 | 0.294 |
| EO Mono 5 | 45508 | 45.5 | 100118 | 100.1 | 2.20 | 15746 | 15.7 | 0.346 |

C: Elastomers

| | Total | Vinyl/ | Vinylidene/ | Vinylene/ | Trisub/ | ENB/ |
|---|---|---|---|---|---|---|
| | Unsats/ | 1000 C | 1000 C | 1000 C | 1000 C | 1000 C |
| | 1000 C | (% Vinyl) | (% Vinylidene) | (% Vinylene) | (% Trisub) | (% ENB) |
| ENGAGE | 0.078 | 0.046 | 0.012 | 0.014 | 0.006 | |
| 8407 | | (58.97%) | (15.38%) | (17.95%) | (7.69%) | |
| ENGAGE | 0.07 | 0.048 | 0.015 | 0.007 | | |
| PV 8669 | | (68.57%) | (21.43%) | (10.00%) | | |
| NORDEL | 1.270 | 0.027 | 0.053 | 0.008 | 0.011 | 1.171 |
| 3720P | | (2.13%) | (4.17%) | (0.63%) | (0.87%) | (92.20%) |
| NORDEL | 1.155 | 0.074 | 0.199 | 0.003 | 0.007 | 0.872 |
| 3722P | | (6.41%) | (17.23%) | (0.26%) | (0.61%) | (75.50%) |
| EO RO6 | 0.71 | 0.46 | 0.13 | 0.09 | 0.03 | |
| | | (64.79%) | (18.31%) | (12.68%) | (4.23%) | |
| EO Tele 1 | 1.078 | 0.471 | 0.101 | 0.023 | 0.009 | 0.474 |
| | | (43.69%) | (9.37%) | (2.13%) | (0.83%) | (43.97%) |
| EO Mono 2 | 0.562 | 0.436 | 0.098 | 0.018 | 0.01 | |
| | | (77.58%) | (17.44%) | (3.20%) | (1.78%) | |
| EO Mono 3 | 0.596 | 0.371 | 0.158 | 0.062 | 0.005 | |
| | | (62.25%) | (26.51%) | (10.40%) | (0.84%) | |
| EO Mono 4 | 0.294 | 0.080 | 0.061 | 0.145 | 0.008 | |
| | | (27.21%) | (20.75%) | (49.32%) | (2.72%) | |
| EO Mono 5 | 0.346 | 0.221 | 0.056 | 0.068 | 0.001 | |
| | | (63.87%) | (16.18%) | (19.65%) | (0.29%) | |

Note, the % of a particular unsaturation (% pu) = [(amt. pu/1000 C)/(amt. total unsat./1000 C)] × 100; where the % pu = % vinyl, % vinylidene, % vinylene, % trisub, or % ENB.

### Polymer Syntheses

### EO R06 (Ethylene/Octene Copolymer)

EO R06 was prepared in a one gallon polymerization reactor that was hydraulically full, and operated at steady state conditions. The catalysts and cocatalysts are listed in Table 2. The solvent, hydrogen, catalysts, and cocatalysts were fed to the reactor according to the process conditions outlined in Tables 3A-3C. The solvent was ISOPAR E, supplied by the ExxonMobil Chemical Company. The reactor temperature was measured at or near the exit of the reactor. The copolymer was isolated and pelletized.

TABLE 2
Catalysts and Cocatalysts

| | Description |
|---|---|
| Catalyst (CAT) | |
| BPP-A | 6′,6″′-(propane-1,3-diylbis(oxy))bis(3-(3,6-di- |
| | tert-butyl-9H-carbazol-9-yl)-3′-fluoro-5-(2,4,4- |
| | trimethylpentan-2-yl)-[1,1′-biphenyl]-2- |
| | ol)dimethyl-zirconium (WO2012027448) |
| Cocatalyst | |
| CoCAT 1 | A mixture of methyldi(C₁₄₋₁₈ alkyl)ammonium |
| | salts of tetrakis(pentafluorophenyl)borate, |
| | prepared by reaction of a long chain trialkylamine |
| | (Armeen ™ M2HT, available from Akzo-Nobel, Inc.), |
| | HCl and Li[B(C₆F₅)₄], substantially as |
| | disclosed in U.S. Pat. No. 5,919,983, Ex. 2 |
| | (no further purification performed) (Boulder |
| | Scientific) |
| CoCAT 2 | Modified methylalumoxane (MMAO) Type 3A |
| | (no further purification performed) (Akzo |
| | Nobel) |

TABLE 3
A: Reactor Conditions

| | Reactor | Reactor | | | | | |
|---|---|---|---|---|---|---|---|
| | Temp., | Pressure, | Solvent, | Ethylene, | Octene, | Hydrogen, | ethylene |
| | ° C. | psig | lb/hr | lb/hr | lb/hr | sccm | conversion, % |
| EO R06 | 197 | 725 | 41.87 | 3.67 | 8.56 | 3.2 | 75.8 |

B: Catalyst Feed Flows and Efficiency

| | | | | Overall Catalyst |
|---|---|---|---|---|
| | | CAT Solution | CAT Solution | Efficiency, |
| | | Flow, | Metal | (g interpolymer/g |
| | CAT | lb/hr | Conc., ppm* | total catalyst metal) |
| EO R06 | BPP-A | 0.42 | 2.15 | 5,230,000 |

*The “ppm” amount based on the weight of the catalyst feed solution.

TABLE 3C
Cocatalyst Feed Flows

| | CoCAT 1 | CoCAT 1 | CoCAT 2 | CoCAT 2 |
|---|---|---|---|---|
| | Solution | Solution | Solution | Solution |
| | Flow, lb/hr | Conc., ppm* | Flow, 1b/hr | Conc., ppm Al** |
| EO R06 | 0.46 | 30.8 | 0.39 | 34.7 |

*The “ppm” amount based on the weight of the co-catalyst feed solution.
**The “ppm” amount of Al based on the weight of the co-catalyst feed solution.

### EO Tele 1 (see WO2020/140058) and EO Mono 2 (see WO2020/140067), EO Mono 3-5

### Synthesis of Tris(2-(Cyclohex-3-en-1-yl)Ethyl) Aluminum Chain Transfer Agent (“CTA 1”)

In a drybox, 4-vinyl-1-cyclohexene (3.2 mL, 24.6 mmol) and tiiisobutylaluminum (2.0 ml, 7.92 mmol) were added to 5 mL of decane, in a vial equipped with a stir bar and a venting needle on the cap. This mixture was heated at 120° C. with stirring for three hours. After three hours, a sample was dissolved in benzene-d6 for ¹H NMR analysis, and another aliquot was hydrolyzed with water and analyzed by GC/MS. ¹H NMR showed all vinyl groups reacted, and the internal double bond remained. GC/MS showed a clean peak at m/z of 110, consistent to the molecular weight of ethylcyclohexene. Accordingly, ¹H NMR and GC/MS confirmed the synthesis of tris(2-(cyclohex-3-en-1-yl)ethyl)aluminum (“CTA 1”) via non-limiting Scheme 1, as shown below:

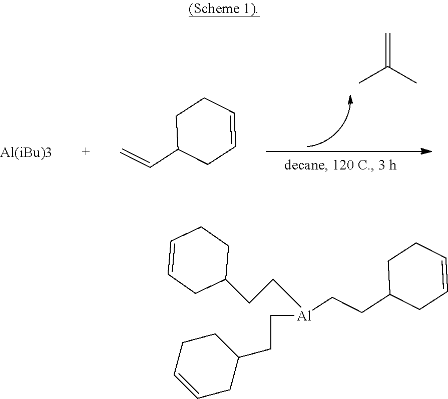

### Catalysts

CAT 1 may be prepared according to the teachings of WO 03/40195 and U.S. Pat. No. 6,953,764 B2, and has the following structure:

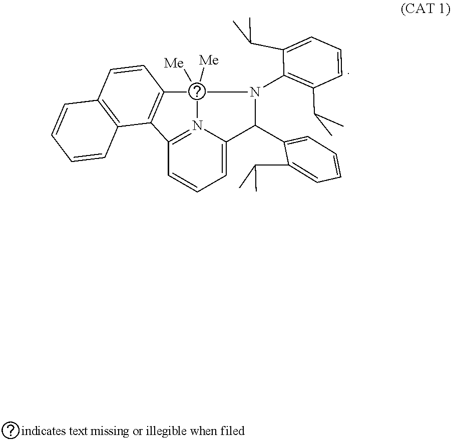

CAT 2 may by prepared according to the teachings of WO 2011/102989 A1, and has the following structure:

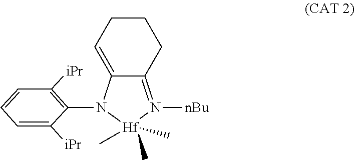

### Continuous Solution Polymerization of EO Tele 1

EO Tele 1 (A¹L¹L²A²) was made via a continuous solution polymerization as follows. The polymerization was carried out in a computer controlled autoclave reactor, equipped with an internal stirrer. Purified mixed alkanes solvent (ISOPAR E available from ExxonMobil), monomers, and molecular weight regulator (hydrogen or chain transfer agent) were supplied to a 3.8 L reactor, equipped with a jacket for temperature control. The solvent feed to the reactor was measured by a mass-flow controller. A variable speed diaphragm pump controlled the solvent flow rate and pressure to the reactor. At the discharge of the pump, a side stream was taken to provide flush flows for the procatalyst, activator, and chain transfer agent (catalyst component solutions) injection lines. These flows were measured by mass flow meters, and controlled by control valves. The remaining solvent was combined with monomers and hydrogen, and fed to the reactor. The temperature of the solvent/monomer solution was controlled by use of a heat exchanger, before entering the reactor. This stream entered the bottom of the reactor. The catalyst component solutions were metered using pumps and mass flow meters, and were combined with the catalyst flush solvent, and introduced into the bottom of the reactor. The reactor was liquid full at “500 psig” with vigorous stirring. Polymer was removed through exit lines at the top of the reactor. All exit lines from the reactor were steam traced and insulated. The product stream was then heated at 230° C., by passing through a post reactor heater (PRH), where beta-H elimination of polymeryl-Al took place. A small amount of isopropyl alcohol was added, along with any stabilizers or other additives, after the PRH, and before devolatilization. The polymer product was recovered by extrusion, using a devolatilizing extruder. The polymerization conditions and results prior to the post reactor heating (PRH) are listed in Tables 4A and 4B.

Abbreviations in the tables are explained as follows: “Co.” stands for comonomer; “sccm” stands for standard cm³/min; “T” refers to temperature; “Cat” stands for Procatalyst; “CAT 1” stands for Procatalyst (CAT 1); “CoCAT-1” refers to the cocatalyst defined in Table 2; “CTA” stands for chain transfer agent”; “Poly Rate” stands for polymer production rate; “Conv” stands for percent ethylene conversion in reactor; and “Eff.” stands for efficiency, kg polymer/g catalyst metal.

TABLE 4A
Polymerization Conditions

| | | | | | | | | Cat. | Cat. |
|---|---|---|---|---|---|---|---|---|---|
| | C2 | Co. | Co. | Solv. | H2 | T | | Conc. | flow |
| | lbs/hr | Type | lbs/hr | lbs/hr | sccm | ° C. | Cat. | ppm Hf | lbs/hr |
| EO Tele 1 | 4.76 | 1-octene | 5.46 | 41.78 | 0 | 118 | CAT 1 | 125.5 | 0.328 |

TABLE 4B
Polymerization Conditions

| | | CTA | CTA | | CoCAT- | Poly. | | | |
|---|---|---|---|---|---|---|---|---|---|
| | | conc. | Flow | CoCAT-1 | 1 Flow | Rate | Conv. | Solids | |
| | CTA | ppm Al | lbs/hr | ppm | lbs/hr | lbs/hr | % | % | Eff. |
| EO Tele 1 | CTA 1 | 9432 | 0.420 | 925 | 0.359 | 6.4 | 88.9 | 13.8 | 0.157 |

### Continuous Solution Polymerization of EO Mono 2EO Mono 5

Continuous solution polymerizations of EO Mono 2, 3, 4, 5, (A¹L1) were carried out in similar manner as that for EO Tele 1 (see above). The polymerization conditions and results prior to post reactor heating (PHR) are listed in Tables 5A and 5B. Here “TEA” stands for triethylaluminum; and “CAT 2” stands for Procatalyst (CAT 2). See above “EO Tele 1 polymerization” for other abbreviations.

TABLE 5A
Polymerization Conditions

| | | | | | | | | Cat. | Cat. |
|---|---|---|---|---|---|---|---|---|---|
| | C2 | Co. | Co. | Solv. | H2 | T | | Conc. | flow |
| | lbs/hr | Type | lbs/hr | lbs/hr | sccm | ° C. | Cat. | ppm Hf | lbs/hr |
| EO Mono 2 | 3.33 | 1-octene | 3.6 | 29.3 | 0 | 115 | CAT 1 | 125.5 | 0.212 |
| EO Mono 3 | 2.85 | 1-octene | 5.6 | 36.2 | 0 | 125 | CAT 2 | 124.8 | 0.097 |
| EO Mono 4 | 2.90 | 1-octene | 6.2 | 36.0 | 0 | 140 | CAT 2 | 63.0 | 0.264 |
| EO Mono 5 | 3.73 | 1-octene | 2.6 | 39.5 | 0 | 140 | CAT 2 | 63.0 | 0.202 |

TABLE 5B
Polymerization Conditions

| | | CTA | CTA | CoCAT- | CoCAT- | Poly. | | | |
|---|---|---|---|---|---|---|---|---|---|
| | | conc. | Flow | 1 | 1 Flow | Rate | Conv. | Solids | |
| | CTA | ppm TEA | lbs/hr | ppm | lbs/hr | lbs/hr | % | % | Eff. |
| BO Mono 2 | TEA | 9827 | 0.744 | 925 | 0.232 | 4.47 | 89 | 13.7 | 0.168 |
| EO Mono 3 | TEA | 9820 | 0.580 | 120 | 0.082 | 3.95 | 85 | 10.1 | 0.325 |
| EO Mono 4 | TEA | 4459 | 0.149 | 1230 | 0.109 | 4.10 | 85 | 10.5 | 0.247 |
| EO Mono 5 | TEA | 9820 | 0.249 | 1230 | 0.083 | 3.88 | 87 | 8.9 | 0.306 |

### Compositions

Compositions are shown in Tables 6-12. For each composition, the polymer pellets were mixed with the curing additives (“Si—H coagent,” peroxide, optional coagent and optional alkoxyl silane coupling agent or other compound) in a sealable fluorinated HDPE bottle of 250 mL. The soaking process occurred via shaking, and imbibition took place for five hours at 50° C.—no liquid residuals were visually seen adhering to the inner wall of the bottle. For Inv. 16, the SiH-PDMS was compounded into LDPE by BRABENDER internal mixer, with a 350 ml bowl, at 110° C. and 30 rpm, and then pelletized by BRABENDER single screw extruder at 110° C.

### Results and Discussion

Curing results are shown in Tables 6-12. For most of the inventive compositions, in general, there was reduction in T90 and an increase in the MH value, relative to the respective comparative. As seen in Table 6, the inventive compositions show a reduction in T90 and an increase in MH. The comparative compositions containing EVA or conventional POE with low unsaturation show a minimal reduction in T90 and a decrease in MH. The MH comparison between A and B, C and D, E and F, suggest less curing due to the addition of the SiH coagent.

As seen in Table 7, the SiH coagent is effective at 0.1 to 0.5 wt % addition in the inventive compositions. Also, the SiH can be used with other coagents, such as TAIC, but is only effective with the POE with high unsaturation, as seen by a decrease in T90 and increase in MH. For the comparative compositions containing a conventional POE and various levels of the SiH coagent, with or without the TAIC coagent, there is minimal change in T90 and the MH value decreased.

As seen in Table 8, the inventive compositions containing the SiH coagent and the EPDM had excellent cure properties (decrease in T90 and increase in MH). Also, the SiH coagent is effect with different types of peroxides. As seen in Table 9, the inventive composition containing the SiH coagent and the POE (unsaturation) or the EPDM polymer had excellent curing properties. The SiH coagent can be used with other coagents, such as TAIC and Vinyl-D4, and in the presence of an alkoxyl silane coupling agent, such as VMMS. As seen in Table 10 and 11, SiH coagents of varying types are effective, including those with only one or two SiH groups, and result in excellent cure properties. The inventive compositions in Table 12 had overall better cure properties.

TABLE 6
Cure Properties

| | Comp. | Comp. | Comp. | Comp. | Comp. | Comp. | Inv. | Comp. | Inv. | Comp. |
|---|---|---|---|---|---|---|---|---|---|---|
| | A | B | C | D | E | F | 1 | G | 2 | H |
| EVA, | 98.75 | 99 | | | | | | | | |
| E282PV | | | | | | | | | | |
| ENGAGE | | | 98.75 | 99 | | | | | | |
| PV 8669 | | | | | | | | | | |
| ENGAGE 8407 | | | | | 98.75 | 99 | | | | |
| EO Tele 1 | | | | | | | 98.75 | 99 | | |
| EO Mono 2 | | | | | | | | | 98.75 | 99 |
| TBEC | 1 | 1 | 1 | 1 | 1 | 1 | 1 | 1 | 1 | 1 |
| SiH-3 | 0.25 | | 0.25 | | 0.25 | | 0.25 | | 0.25 | |
| Total | 100 | 100 | 100 | 100 | 100 | 100 | 100 | 100 | 100 | 100 |
| (wt. parts) | | | | | | | | | | |
| ML, dN*m | 0.09 | 0.08 | 0.06 | 0.08 | 0.02 | 0.02 | 0.02 | 0.02 | 0.02 | 0.02 |
| MH, dN*m | 3.51 | 4.03 | 1.75 | 2.16 | 0.93 | 1.08 | 4.34 | 1.61 | 4.74 | 4.41 |
| T90, min. | 9.35 | 9.71 | 13.70 | 13.73 | 14.56 | 14.93 | 15.34 | 18.44 | 12.08 | 15.49 |
| MH change | −12.9% | | −19.0% | | −13.9% | | 169.6% | | 7.5% | |
| by adding | | | | | | | | | | |
| SiH coagent | | | | | | | | | | |
| T90 change | −3.7% | | −0.2% | | −2.5% | | −16.8% | | −22.0% | |
| by adding | | | | | | | | | | |
| SiH coagent | | | | | | | | | | |

TABLE 7
Cure Properties

| | Comp. | Comp. | Comp. | Comp. | Comp. | Comp. | Inv. | Inv. | Inv. | Comp. | Inv. |
|---|---|---|---|---|---|---|---|---|---|---|---|
| | D | C | I | J | K | G | 3 | 1 | 4 | L | 5 |
| ENGAGE PV 8669 | 99 | 98.75 | 98.5 | 98.5 | 98.25 | | | | | | |
| EO Tele 1 | | | | | | 99 | 98.9 | 98.75 | 98.5 | 98.75 | 98.5 |
| TBEC | 1 | 1 | 1 | 1 | 1 | 1 | 1 | 1 | 1 | 1 | 1 |
| SiH-3 | | 0.25 | 0.5 | | 0.25 | | 0.1 | 0.25 | 0.5 | | 0.25 |
| TAIC | | | | 0.5 | 0.5 | | | | | 0.25 | 0.25 |
| Total | 100 | 100 | 100 | 100 | 100 | 100 | 100 | 100 | 100 | 100 | 100 |
| (wt. parts) | | | | | | | | | | | |
| ML, dN*m | 0.08 | 0.06 | 0.06 | 0.06 | 0.07 | 0.02 | 0.01 | 0.02 | 0.01 | 0.01 | 0.01 |
| MH, dN*m | 2.16 | 1.75 | 1.5 | 3.8 | 3.43 | 1.61 | 3.73 | 4.34 | 4.62 | 3.3 | 5.29 |
| T90, min. | 13.73 | 13.70 | 13.14 | 9.91 | 10.06 | 18.44 | 16.36 | 15.34 | 15.4 | 17.02 | 15.1 |
| MH change | | −19.0% | −30.6% | | −9.7% | | 131.7% | 169.6% | 187.0% | | 60.3% |
| by adding | | | | | | | | | | | |
| SiH coagent | | | | | | | | | | | |
| T90 change | | −0.2% | −4.3% | | 1.5% | | −11.3% | −16.8% | −16.5% | | −11.3% |
| by adding | | | | | | | | | | | |
| SiH coagent | | | | | | | | | | | |

TABLE 8
Cure Properties

| | Comp. | Comp. | Comp. | Comp. | Comp. | Comp. | Inv. | Comp. |
|---|---|---|---|---|---|---|---|---|
| | M | N | O | P | Q | R | 6 | S |
| EVA | 98.75 | 99 | | | | | | |
| ENGAGE PV | | | 98.75 | 99 | | | | |
| 8669 | | | | | | | | |
| ENGAGE | | | | | 98.75 | 99 | | |
| 8407 | | | | | | | | |
| EO Tele 1 | | | | | | | 98.75 | 99 |
| EO Mono 2 | | | | | | | | |
| EPDM 3720 | | | | | | | | |
| EO R06 | | | | | | | | |
| CH-80MO | | | | | | | | |
| TAEC | 1 | 1 | 1 | 1 | 1 | 1 | 1 | 1 |
| SiH-3 | 0.25 | | 0.25 | | 0.25 | | 0.25 | |
| Total | 100 | 100 | 100 | 100 | 100 | 100 | 100 | 100 |
| (wt. parts) | | | | | | | | |
| ML, dN*m | 0.08 | 0.09 | 0.06 | 0.07 | 0.01 | 0.01 | 0.02 | 0.01 |
| MH, dN*m | 2.63 | 3.02 | 0.97 | 1.28 | 0.41 | 0.53 | 5.81 | 3.62 |
| T90, min. | 5.63 | 5.63 | 9.61 | 9.71 | 10.63 | 11.11 | 11.17 | 13.14 |
| MH change | −12.9% | | −24.2% | | −22.6% | | 60.5% | |
| by adding | | | | | | | | |
| SiH coagent | | | | | | | | |
| T90 change | 0.0% | | −1.0% | | −4.3% | | −15.0% | |
| by adding | | | | | | | | |
| SiH coagent | | | | | | | | |
| | Inv. | Comp. | Inv. | Comp. | Inv. | Comp. | Inv. | Comp. |
| | 7 | T | 8 | U | 9 | V | 10 | W |
| EVA | | | | | | | | |
| ENGAGE PV | | | | | | | | |
| 8669 | | | | | | | | |
| ENGAGE | | | | | | | | |
| 8407 | | | | | | | | |
| EO Tele 1 | | | | | | | | |
| EO Mono 2 | 98.75 | 99 | 99 | 99.25 | | | | |
| EPDM 3720 | | | | | 98.75 | 99 | | |
| EO R06 | | | | | | | 98.75 | 99 |
| CH-80MO | | | 0.75 | 0.75 | | | | |
| TAEC | 1 | 1 | | | 1 | 1 | 1 | 1 |
| SiH-3 | 0.25 | | 0.25 | | 0.25 | | 0.25 | |
| Total | 100 | 100 | 100 | 100 | 100 | 100 | 100 | 100 |
| (wt. parts) | | | | | | | | |
| ML, dN*m | 0.02 | 0.02 | 0.03 | 0.03 | 0.74 | 0.74 | 0.03 | 0.03 |
| MH, dN*m | 4.9 | 5.08 | 3.8 | 4.25 | 6.71 | 6.05 | 3.3 | 3.77 |
| T90, min. | 7.26 | 8.38 | 8.61 | 9.52 | 8.75 | 9.48 | 8.14 | 8.88 |
| MH change | −3.5% | | −10.6% | | 10.9% | | −12.5% | |
| by adding | | | | | | | | |
| SiH coagent | | | | | | | | |
| T90 change | −13.4% | | −9.6% | | −7.7% | | −8.4% | |
| by adding | | | | | | | | |
| SiH coagent | | | | | | | | |

TABLE 9
Cure Properties

| | Comp. | Inv. | Comp. | Inv. | Comp. | Inv. |
|---|---|---|---|---|---|---|
| | X | 11 | Y | 12 | Z | 13 |
| EO Mono 2 | 98.5 | 98.25 | 98.5 | 98.25 | | |
| NORDEL 3720 | | | | | 98.25 | 98 |
| TAEC | 1 | 1 | 1 | 1 | 1 | 1 |
| SiH-3 | | 0.25 | | 0.25 | | 0.25 |
| TAIC | 0.5 | 0.5 | | | 0.5 | 0.5 |
| Vinyl D4 | | | 0.5 | 0.5 | | |
| VMMS | | | | | 0.25 | 0.25 |
| Total | 100 | 100 | 100 | 100 | 100 | 100 |
| (wt. parts) | | | | | | |
| ML, dN*m | 0.01 | 0.02 | 0.02 | 0.02 | 0.71 | 0.73 |
| MH, dN*m | 6.84 | 7.39 | 5.49 | 6.44 | 8.04 | 9.22 |
| T90, min. | 10.38 | 9.83 | 10.47 | 9.73 | 8.51 | 6.95 |
| MH change | | 8.0% | | 17.3% | | 14.7% |
| by adding | | | | | | |
| SiH coagent | | | | | | |
| T90 change | | −5.3% | | −7.1% | | −18.4% |
| by adding | | | | | | |
| SiH coagent | | | | | | |

TABLE 10
Cure Properties

| | Comp. | Inv. | Inv. | Inv. | Comp. | Inv. | Inv. |
|---|---|---|---|---|---|---|---|
| | G | 14 | 15 | 16 | H | 17 | 18 |
| EO Tele 1 | 99 | 98.85 | 98.5 | 97.4 | | | |
| EO Mono 2 | | | | | 99 | 98.85 | 98.5 |
| TBEC | 1 | 1 | 1 | 1 | 1 | 1 | 1 |
| SiH-1 | | | 0.5 | | | | 0.5 |
| SiH-2 | | 0.15 | | | | 0.15 | |
| SiH-PDMS | | | | 1.6 | | | |
| Total | 100 | 100 | 100 | 100 | 100 | 100 | 100 |
| (wt. parts) | | | | | | | |
| ML, dN*m | 0.02 | 0.02 | 0.01 | 0.02 | 0.02 | 0.02 | 0.02 |
| MH, dN*m | 1.61 | 4.73 | 3.87 | 4.83 | 4.41 | 5.47 | 5.29 |
| T90, min. | 18.44 | 15.01 | 15.74 | 15.05 | 15.49 | 12.3 | 12.93 |
| MH change | | 193.8% | 140.4% | 200.0% | | 24.0% | 20.0% |
| by adding | | | | | | | |
| SiH coagent | | | | | | | |
| T90 change | | −18.6% | −14.6% | −18.4% | | −20.6% | −16.5% |
| by adding | | | | | | | |
| SiH coagent | | | | | | | |

TABLE 11
Cure Properties

| | Comp. | Inv. | Comp. | Inv. | Inv. | Comp. | Inv. | Inv. |
|---|---|---|---|---|---|---|---|---|
| | AA | 19 | BB | 20 | 21 | G | 22 | 23 |
| EO Tele 1 | | | | | | 99.00 | 98.63 | 98.36 |
| EO Mono 3 | 99.00 | 98.75 | 99.00 | 98.63 | 98.36 | | | |
| TAEC | 1.00 | 1.00 | | | | | | |
| TBEC | | | 1.00 | 1.00 | 1.00 | 1.00 | 1.00 | 1.00 |
| SiH-3 | | 0.2 | | | | | | |
| SiH-4 | | | | 0.37 | | | 0.37 | |
| SiH-5 | | | | | 0.64 | | | 0.64 |
| Total | 100 | 100 | 100 | 100 | 100 | 100 | 100 | 100 |
| ML, dN*m | 0.01 | 0.01 | 0 | 0 | 0 | 0.02 | 0.00 | 0.00 |
| MH, dN*m | 2.56 | 3.47 | 1.86 | 4.09 | 3.8 | 1.61 | 4.43 | 4.7 |
| T90, min | 13.26 | 8.61 | 17.74 | 13.15 | 13.28 | 18.44 | 14.98 | 15.03 |
| MH change | | 35.6% | | 119.9% | 104.3% | | 175.2% | 191.9% |
| by adding | | | | | | | | |
| SiH coagent | | | | | | | | |
| T90 change | | −35.1% | | −25.9% | −25.1% | | −18.8% | −18.5% |
| by adding | | | | | | | | |
| SiH coagent | | | | | | | | |

TABLE 12
Cure Properties

| | Comp. | Comp. | Inv. | Inv. |
|---|---|---|---|---|
| | CC | DD | 24 | 25 |
| EO Mono 4 | 99.80 | | 99.75 | |
| EO Mono 5 | | 99.80 | | 99.75 |
| TBEC | 0.2 | 0.2 | 0.2 | 0.2 |
| SiH-3 | | | 0.05 | 0.05 |
| Total | 100 | 100 | 100 | 100 |
| (wt. parts) | | | | |
| ML, dN*m | 0.69 | 0.59 | 0.70 | 0.60 |
| MH, dN*m | 2.96 | 6.16 | 3.06 | 6.36 |
| T90, min. | 13.21 | 13.78 | 13.23 | 13.51 |
| MH change | | | 3.4% | 3.2% |
| by adding | | | | |
| SiH coagent | | | | |
| T90 change | | | 0.2% | −2.0% |
| by adding | | | | |
| SiH coagent | | | | |

1. A process to form a crosslinked composition, the process comprising applying heat, and optionally radiation, to a composition that comprises at least the following components:
a) an elastomer, or an olefin-based polymer that has a density >0.920 g/cc, and wherein component a has a total unsaturation ≥0.20 /1000C;
b) a molecule comprising at least one Si—H group;
c) at least one peroxide; and
d) optionally, at least one crosslinking coagent different from component b.

2. A process to form a crosslinked composition, the process comprising applying radiation, and optionally heat, to a composition that comprises the following components:
a) an elastomer, or an olefin-based polymer that has a density >0.920 g/cc, and wherein component a has a total unsaturation ≥0.20/1000 C;
b) a molecule comprising at least one Si—H group.

3. The process of claim 1, wherein component a is an elastomer.

4. The process of claim 1, wherein the elastomer has a density from 0.860 g/cc to 0.920 g/cc.

5. The process of claim 1, wherein the elastomer is selected from a telechelic polyolefin of the formula A¹L¹L²A², an unsaturated polyolefin of the formula A¹L¹, an ethylene/alpha-olefin/nonconjugated polyene interpolymer, or an ethylene/alpha-olefin interpolymer.

6. The process of claim 1, wherein the component b comprises ≥2 Si—H groups.

7. The process of claim 1, wherein the component b comprises ≥1 siloxane group(s) (—Si—O—Si—).

8. The process of claim 1, wherein the silicon of the SiH in component b is bonded to at least one alkyl group (R).

9. The process of claim 1, wherein the silicon of the SiH in component b is bonded to at least one alkoxyl group (RO).

10. A crosslinked composition formed from the process of claim 1.

11. A composition comprising at least the following components:
a) an elastomer, or an olefin-based polymer that has a density >0.920 g/cc, and wherein component a has a total unsaturation ≥0.20/1000 C;
b) a molecule comprising at least one Si—H group;
c) at least one peroxide; and
d) optionally, at least one crosslinking coagent different from component b.

12. The composition of claim 11, wherein component a is an elastomer.

13. The composition of claim 11, wherein the elastomer has a density from 0.860 g/cc to 0.920 g/cc.

14. The composition of claim 11, wherein the elastomer is selected from a telechelic polyolefin of the formula A¹L¹L²A², an unsaturated polyolefin of the formula A1L1, an ethylene/alpha-olefin/nonconjugated polyene interpolymer, or an ethylene/alpha-olefin interpolymer.

15. The composition of claim 11, wherein the component b comprises ≥2 Si—H groups.

16. The composition of claim 11, wherein the component b comprises ≥1, siloxane group(s) (—Si—O—Si—).

17. The composition of claim 11, wherein the silicon of the SiH in component b is bonded to at least one alkyl group (R).

18. The composition of claim 11, wherein the silicon of the SiH in component b is bonded to at least one alkoxyl group (RO).

19. A crosslinked composition formed the composition of claim 11.

20. An article comprising at least one component formed from the composition of claim 10.
